(19) United States
(12) Patent Application Publication
(10) Pub. No.: US 2003/0209103 A1
(43) Pub. Date: Nov. 13, 2003

(54) Cooper-based sintering sliding material and multi-layered sintered sliding member

(75) Inventors: Takemori Takayama, Osaka (JP); Tetsuo Ohnishi, Yawata-shi (JP); Yoshikiyo Tanaka, Osaka (JP); Keiichi Maeda, Osaka (JP); Kanichi Sato, Osaka (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/395,725

(22) Filed: Mar. 24, 2003

(30) Foreign Application Priority Data
May 10, 2002 (JP) 2002-135275

(51) Int. Cl. B32B 15/20

(52) U.S. Cl. 75/231; 428/676

(57) ABSTRACT

In a copper-based sintering sliding material, to reduce attacking power to the counter material by expressing an ability to scrape a local adhered object on the sliding surface, improve abrasion resistance of the material, and suppress the abrasive heat generation due to the hard phase, thereby improving the seizure limit, heat shock resistant ceramics comprising two or more selected from SiO₂ and/or SiO₂, Al₂O₃, LiO₂, TiO₂ and MgO are dispersed in an amount of 0.05 to 0.5% by weight or less, as nonmetallic particles comprising one or more kind(s) selected from finely grinded oxides, carbides and nitrides.

### TECHNICAL FIELD

The present invention relates to a copper-based sintering sliding material and a multi-layered sintered sliding member fabricated by sinter-bonding the copper-based sintering sliding material to an iron-based material.

### BACKGROUND ART

In general, a bearing material is selected from various kinds of copper alloys depending on the conditions such as oil lubrication circumstance, sliding speed and sliding surface pressure and the like. When it is used in oil, relatively soft bronze (e.g., BC3 and BC6), phosphor bronze (e.g., PBC2A), lead bronze (e.g., LBCs 2 to 5), Kelmet (e.g., KJs 1 to 4) casting materials are used, whereas when the oil lubrication is a little poor, bronze-based oil-containing bearings formed of copper-based sintered bearing materials wherein graphite serving as a solid lubricant is added to Cu—Sn, Cu—Sn—Pb are often used.

On the other hand, in a tracker roller section around legs of construction equipment, it is often used a multi-layered bearing which is obtainable by sintering powder of a lead bronze-based sintering material spread on a metal backing formed of a steel and then pressurizing it down by means of a rolling mill to execute re-sintering for sinter-bonding them. Also, a multi-layered bearing which is provided with a soft metal such as Sn by overlaying is widely used as an engine metal. Furthermore, in high bearing, low sliding speed conditions which are likely to cause a boundary lubrication condition, soft high strength brass having excellent seizure resistance and abrasion resistance (e.g., HBsCl-4) has been used (See Engineering Data Book for Copper based Alloy Casting, pp. 134-155, edited by Japan Non-ferrous Metal Casting Association, The Materials Process Technology Center (SOKEIZAI CENTER), Jul. 30, 1988).

The recent demand for bronze-based and lead bronze-based sliding materials which are most widely used is to improve the seizure resistance and abrasion resistance under high sliding speeds, as well as to exert excellent abrasion resistance even under low sliding speeds and bad lubrication conditions. Furthermore, in consideration of the environment issue in recent years, it is desired to achieve characteristics of lead bronze-based sintering sliding material having stable seizure resistance as well as excellent conformability without adding Pb.

By the way, frequent occurrences of galling and the resulting abnormal abrasions in the sliding condition under high speed and high bearing condition may result from occurrence of adhesion due to a contact between metals under boundary lubrication and rapid growing of such adhesion. For addressing this problem, it is often the case that an overlaid layer formed of soft metal such as Sn is formed as is the engine metal so as to improve the conformability, thereby improving the fluid lubricity. However, in the case where the bearing becomes higher, or in the case where the boundary lubricity increases due to changes in vibration load, accelerating/decelerating condition and the like during sliding, durability and life of the overlaid layer deteriorates, so that it is necessary to improve the sliding performance and durability of the lead bronze-based sintering sliding material.

On the other hand, regarding lead bronze-based or lead copper-based sliding materials containing a large amount of Pb, in particular, when the sliding speed is significantly high, when the rotating direction (sliding direction) frequently changes to cause repeated accelerating/decelerating so that the sliding is associated with large changes in sliding speed, or when the counter material has a large surface roughness, the abrasion rapidly proceeds, posing the problem that sufficient durability to bear long-time use cannot be ensured.

From the view point of improving the abrasion resistance of the sliding material, it is reasonable to use the above-described high strength brass, however, since the high strength brass has normally high hardness of as high as Hv180 or more, such a material is inferior in conformability and thus may be used only in high load and low speed conditions. Furthermore, since the high strength brass has an extremely high vapor pressure and contains Zn which is easily oxidized in high concentration, it is impossible to conduct bonding with steels by coordinate casting. This disables the high strength brass to be used for cylinder blocks, valve plates and the like formed of iron-base material for hydraulic pumps and motors by utilizing the coordinate casting, which is one of the primary objects of the present invention as will be described later.

As for the above-described abrasion resistance and seizure resistance, oil-containing copper-based sintering sliding materials also have similar problems although the degree of problem is not the same. Furthermore, also in brass-based sintering sliding materials, it is difficult to bond them to, for example, iron-based material because of Zn contained therein in high concentration, so that the same problem arises that they cannot be used for cylinder blocks, valve plates and the like by subjecting it to bond by casting.

In addition, from the view point of environmental issue, great demand for stopping the use of Pb contained in lead bronze-based sliding materials is recognized in recent years.

In consideration of the above, as a prior art which improves characteristics of bronze-based sintering sliding materials, the art that is disclosed in Japanese Patent Laid-Open No. 11-350008(1999) can be recited. This disclosed art proposes a multi-layered bronze-based sintered member which is produced by spreading mixed powder of bronze not containing Pb and 3 to 13% by weight of W powder on a metal backing of steel plate, sintering the same, and performing rolling process to achieve high density followed by re-sintering, as well as a bronze-based sintering sliding material thereof. According to this disclosed art, W has good affinity with respect to a bronze matrix and hence has high bonding strength so that W will not leave due to the sliding resistance or the like. Additionally, since W has appropriate hardness that is larger than that of the bronze matrix (W; Hv350 to 500, Mo; Hv200 to 250) but is softer (smaller) than that of ceramics particles that are too hard to damage a counter material, a part of W particles locally project out to the counter sliding material to form an uneven sliding surface including projections and recesses, and a lubrication oil film is formed by steps of these projections and recesses. Also since the melting point of W is high (3410° C.), it will not melt as is Pb, and sliding characteristics without seizure and unevenness of sliding are ensured, as well as it will not wear the counter steel material.

In this disclosed art, however, since as much as 3 to 13% by weight of spread particles W are required for forming the lubrication oil film, a cost problem arises. Moreover, in sliding conditions of higher peripheral speeds and higher bearings, even if the W particles do not melt as is Pb, adhesion portions are formed due to local contact with the counter material. However, these adhesion portions thus formed cannot be prevented from growing because the function of scraping the local adhesion portions is not sufficiently exerted due to insufficient hardness of the W particles. Accordingly, there arises a problem that improvement in abrasion resistance is not sufficiently achieved, and as a result, seizure resistance is not sufficiently improved due to generation of a large amount of adhered powder.

Furthermore, in Japanese Patent Laid-Open No. 7-166278(1995), it is disclosed that by adding 0.5 to 5% by weight of Mo or 0.5 to 15% by weight of Fe—Mo to a bronze-based and/or lead bronze-based sintering sliding material containing 4 to 12% by weight of Sn or, and additionally 0.1 to 10% by weight of Pb, excellent lubrication function and affinity to oil are imparted to give low friction coefficient and high abrasion resistance. Also in this disclosed art, as is Japanese Patent Laid-Open No. 11-350008(1999) as discussed above, since the hardness of Mo particles is not sufficient, there arises a problem that sufficient improvement of abrasion resistance is not achieved, and as a result, seizure resistance is not sufficiently improved due to generation of a large amount of adhered powder.

In the production method described in the above Japanese Patent Laid-Open No. 7-166278(1995), a technique relating to a multi-layered sintered member with improved mechanical strength of sintered body is disclosed, wherein a rolled powder mold formed from powder of a bronze-based and/or lead bronze-based sintering sliding material is placed on a metal backing made of iron plated with copper, and a pressure sintering and a sinter-bonding are executed while applying a pressure of less than or equal to 10 kg/cm². Since this production method is based on the pressure-sinter-bonding method, there are many restrictions for the shapes of applied components, and a problem of extremely low productivity due to facility restrictions arises. Also a problem that the cost cannot be reduced arises. Furthermore, in the case of containing a large amount of Pb which is the most effective to ensure conformability in respect of the property of material, since Pb is a component having a low melting point, it is easily flown out of the sintered body when the sintering is executed in a pressurized condition, and Sn components and the like will also flow out together. Therefore, a problem that the above-mentioned sintering sliding material cannot contain large amounts of Sn and Pb, and additionally an environmental problem due to flowing out of Sn and Pb components during production process arise.

As others, a method of adding layered solid lubricants such as molybdenum disulfide (MoS₂), tungsten disulfide (WS₂) and graphite to copper-based sintering sliding materials for the purpose of improving the conformability and seizure resistance under high bearing and low-speed sliding environments where the lubrication condition is serious, has been well known. However, since molybdenum disulfide and tungsten disulfide are likely to decompose during the sintering to form hard copper sulfide (Cu₂S), a large amount should be added so as to realize a sufficient lubrication action, which leads a problem that the sintered body is fragile and the cost rises.

Furthermore, when graphite is added, due to the fact that the graphite is not reactive with bronze-based and lead bronze-based sintering materials, and the sintering property of the sintered body is significantly suppressed, and the strength of the sintering material is weakened, and it is extremely difficult to be wet with the Sn and Pb-rich liquid phase generated during the sintering, there is a problem that the sweating during the sintering is made significant and a plurality of outflow pores are formed. Furthermore, due to the fact that it becomes difficult to densify the sintered layer if the remaining graphite increases, and graphite is a porous substance, problems arises that the boundary lubricity increases and that sliding characteristics under high-speed oil lubrication are not improved as much as expected.

For applications which are completely different from sliding materials for bearings, in the field of porous bronze-based sintering material used as a friction material for brake or clutch, materials having high friction coefficient characteristics for restraining high-speed rotating body in a dry, semidry or boundary lubrication condition have been developed. In these materials, as shown in Tables 1 to 3 (Hanazawa, Journal of the Japan Society for Composite Materials 3 (1), 8, 1977 and Industries and Products, No. 59, Ceramics Data Book 76, p.336, 1976), based on adding a large amount, 5 to 15% by weight of graphite so as to impart porous and low Young s modulus characteristics, a solid lubricant graphite which is superior in heat resistance or a heat-stable metal such as Mo is added for preventing fusion and seizing with a counter material at the time of braking, and 3 to 20% by weight of hard particles (nonmetal particles) such as SiO₂ or mullite are added for preventing plastic flow of the base metal of the friction material, and the surface of the counter material is appropriately grinded, whereby abrasion resistance of the friction material is improved and high friction coefficient is reliably increased.

TABLE 1
Material composition of typical metallic-based cermet-based
friction material (% by weight)

| | component | | | | | | | | |
|---|---|---|---|---|---|---|---|---|---|
| | | | | abrasion | | | | lubricant | |
| | metalic component | | | resistive component | | | | component | |
| classification | Cu | Sn | Zn | silica | mullite | iron | Mo | graphite | Pb |
| metalic −1 | 67.3 | 5.3 | | 4.4 | | 7.1 | | 7.1 | 8.8 |
| metalic −2 | 60˜75 | 5˜10 | | 2˜7 | | 5˜7 | | 5˜10 | 5˜10 |
| metalic −3 | 62 | 7 | | 4 | | 8 | | 7 | 12 |
| cermet −1 | 60 | | | 5 | 20 | | 5 | 10 | |
| cermet −2 | 50 | | | 5 | 20 | 10 | 5 | 10 | |
| cermet −3 | 47 | 3 | 5 | 4 | 20 | 8 | 5 | 8 | |

TABLE 2
Typical composition of cermet lining for aircraft brake (% by weight)

| | component | | | | | | | | |
|---|---|---|---|---|---|---|---|---|---|
| | | | | abrasion | | | | lubricant | |
| | metalic component | | | resistive component | | | | component | |
| classification | Cu | Sn | Zn | silica | mullite | iron | Mo | graphite | Pb |
| example 1 | Bal. | 3˜10 | 3˜10 | 20˜30 | | | | 5˜10 | |
| example 2 | 60 | | | 5 | 20 | | 5 | 10 | |
| example 3 | 50 | | | 5 | 20 | 10 | 5 | 10 | |

TABLE 3
Typical composition of cermet-based friction material for general use
(% by weight)

| | component | | | | | | | | | |
|---|---|---|---|---|---|---|---|---|---|---|
| | metalic | | | abrasion | | | | lubricant | | |
| | component | | | resistive component | | | | component | | |
| classification | Cu | Sn | Zn | silica | mullite | iron | Mo | graphite | Pb | Bi |

| | | | | | | | |
|---|---|---|---|---|---|---|---|
| example 4 | Bal. | 5˜10 | 3˜6 | 3˜6 | 5˜10 | 5˜10 | |
| example 5 | Bal. | 3˜6 | 3˜6 | | | 4˜6 | |
| example 6 | Bal. | 5˜10 | 3˜5 | 3˜5 | 10˜15 | 10˜15 | |
| example 7 | Bal. | 3˜6 | 3˜6 | 3˜5 | 5˜10 | | 5˜10 |

However, if these friction materials are used as a sliding material as in the present invention, the following problems arise:

1) Heat generation on the sliding surface due to high friction coefficient will cause a problem.

2) Since the nonmetallic powder has high hardness, the counter material is excessively worn.

3) Since the large amount of nonmetallic material is difficult to bond to the metallic base, the strength of the sintered body decreases, and the own abrasion resistance is insufficient. Furthermore, the nonmetallic material is likely to leave from the friction surface, and the leaving powder may wear or damage components other than the friction region.

4) The friction material and the counter material are designed on the assumption that they are regularly exchanged as wearing consumable components.

On the other hand, as for the optimization of the hard spread particles to be used in the bronze-based sintered friction material, examples disclosed in Japanese translation of PCT publication No. 7-508799(1995) can be recited. This publication discloses that by containing 5 to 40% by weight of hard particles having a size in the range of 50 to 300 μm and a hardness of Hv=600 or more, such as carbides of Cr, Mo, W, V and the like, oxides of Al, Mo and the like, oxides of Cr, Ni, Zr and the like, it is possible to obtain materials having a friction coefficient of as high as possible which is independent of temperature, sliding speed, contact pressure and the like conditions. Also in these materials, the friction coefficient is apparently too high to be used as a bronze-based sliding material, and it is obvious that the similar problem as described above occurs.

Furthermore, in the case of multi-layered sintered sliding member such as engine metal in which a lead bronze-based sintering sliding material as described above is sinter-bonded to a steel plate, in the method of producing the same, since the sinter-bonding is executed while alloy powder having a composition of a lead bronze-based sintering sliding material is spread on the steel plate, in performing sinter-bonding at a temperature of at least the peritectic crystallization temperature (about 800° C.) or higher of Cu—Sn, the spread alloy powder contracts due to sintering, to lead a problem that it is easily peeled during sinter-bonding. Additionally, in the case of sinter-bonding bronze-based alloy powder to which Pb is not added, it is necessary to execute the sintering at a temperature which is higher than the peritectic crystallization temperature in order to generate a liquid phase which is essential for sinter-bonding, and during this, the spread alloy powder contracts more significantly than the lead bronze-based material, leading a problem that it cannot be sinter-bonded to the steel plate.

The present invention was devised in consideration of the problems as described above, and the first object of the invention is to improve the seizure resistance and abrasion resistance of a copper-based sintering sliding material, as well as to reduce the attacking power to the counter material while expressing a scraping function of a local adhered object on the sliding surface, by adding an appropriate amount of hard dispersion phase having excellent adhesion resistance to iron to the copper-based sintering sliding material, or to provide an inexpensive copper-based sintering sliding material having improved seizure limitation by further adding a soft dispersion phase having excellent adhesion resistance and lubricity into the copper-based sintering sliding material, thereby suppressing the friction heat generation due to the above hard phase.

Also, the second object of the present invention is to provide an inexpensive multi-layered sintered sliding member capable of obtaining stable sinter-bondability by adding an element which regulates contraction due to sintering of the spread layer and/or an element which expands the spread layer with respect to the above-mentioned multi-layered sintered sliding member which is obtainable by sinter-bonding powder of a bronze-based and lead bronze-based sintering material spread on a steel plate.

### SUMMARY OF THE INVENTION

In achieving the above objects, the present invention has developed a copper-based sintering sliding material having the following features (1) and (2) so as to provide a copper-based sintering sliding material which is superior in sliding characteristics not only under high-speed and high bearing conditions but also under low-speed and high bearing conditions.

(1) By optimizing the material quality, the adding amount and the dispersion phase size of nonmetallic hard dispersion particles and intermetallic compound particles (hard first dispersion particles) having excellent adhesion resistance to iron which is to be a counter material, and excellent thermal shock resistance, the seizure resistance and the abrasion resistance are improved and the attacking power to the counter material is reduced while realizing a function of scraping a local adhered object on the sliding surface.

In addition, in more serious sliding environments,

(2) A soft dispersion phase (second dispersion particles) having excellent adhesion resistance and lubricity is added to the copper-based sintering sliding material, whereby the friction heat generation due to the hard phase is suppressed and the seizure limitation (sliding characteristic) is improved.

Furthermore, according to the present invention, by finely dispersing nonmetallic hard dispersion particles such as ceramics and intermetallic compound particles having excellent adhesion resistance to iron and heat shock resistance in the copper-based sintering sliding material, the attacking power to the counter material is minimized, whereby the seizure resistance is improved and an amount of Pb to be added is reduced or use of Pb is eliminated.

Furthermore, by dispersing metallic and/or alloy particles such as Mo, W, Cr, Fe and Co exhibiting significant two-phase separability with respect to Cu, and making the crystal particle size of the copper-based sintering sliding material smaller so that Pb and intermetallic compound are dispersed more finely, the seizure resistance is improved. Also, by dispersing the above-mentioned hard first dispersion particles, the abrasion resistance and the seizure resistance are improved. In particular, we proved that bronze-based, lead bronze-based sintering sliding materials in which particles of Mo, W and the like are dispersed with a small amount of hard first dispersion particles (nonmetallic compound and intermetallic compound) being dispersed exhibit very excellent seizure resistance and abrasion resistance when they are sinter-bonded on the bottom surface of a hydraulic pump or a cylinder block of motor which slides under high-speed and high bearing condition while associated with a whirling as will be described later. In addition, it was found that since Fe—C alloy particles containing carbon in amount of more than or equal to 0.15% by weight can organize a martensitic structure of high hardness by means of cooling or other heat treatments following the sintering, the abrasion resistance can be readily improved.

Furthermore, according to the present invention, as is the case of the above-mentioned cylinder block, with emphasis on ensuring the sintering property of the copper-based sintering sliding material and using the material being sinter-bonded to iron-based materials, we proved that by adding 1 to 16% by weight of Sn so as to allow appearance of a liquid phase which has satisfactory wetability with respect to iron-based materials, and by adding alloy elements such as Si, Al, Ti, Cr and P, the bondability to the iron-based materials is significantly increased.

In addition to the above, we also found that when Sn is added in an amount higher than 12% by weight, the Cu—Sn intermetallic compound particles (δ phase) that is otherwise existing in liquid phase during sintering in the normal temperature range of 800° C. or higher precipitate in the grain boundary portion in the cooling and solidifying process, and also in the matrix a β phase finely precipitates, so that the spreadability is suppressed and the adhesivity is significantly reduced. Among others, this function is very important in such a sliding condition that is associated with a whirling often occurring in a hydraulic pump or a cylinder block of motor as will be described later. The same applies to the above-mentioned sliding materials in which a large amount of intermetallic compound phase is dispersed and precipitated, and sliding materials in which a small amount of hard particles such as oxides, carbides and nitrides are added.

On the other hand, we also found that with respect to the multi-layered sintered sliding member obtained by sinter-bonding powder of the above bronze-based and lead bronze-based sintering materials spread on a steel plate, in order to prevent insufficient sinter-bonding with the metal backing resulting from the fact that the spread alloy powder contracts more significantly than the lead bronze-based material, by adding a substance which prevents contraction of the spread layer due to the sintering, it is possible to achieve stable sinter-bondability.

In brief, the copper-based sintering sliding material according to the present invention is first, characterized in that nonmetallic particles comprising one or more kind(s) selected from grinded hard oxides, carbides, nitrides and carbonitrides are dispersed in the range of 0.2% by volume, inclusive, to 4% by volume, exclusive.

In the present invention, said nonmetallic particles are preferably oxides-based heat shock resistant ceramics comprising one or two kind(s) selected from SiO₂ and/or Si, Al, Li, Ti, Mg and Zr. Furthermore, as the nonmetallic particles, those having an average particle diameter of less than or equal to 70 μm can be used, however, particles having a particle size of less than or equal to 45 μm and/or prepared in fibrous state are more preferred.

Also in the present invention, when used as the nonmetallic particles, above-mentioned carbides, nitrides and carbonitrides are preferably WC, TiC, TiN, TiCN, Mo₂C, Si₃N₄ and the like which are often used in a cutting tool material, and their average particle diameters are preferably adjusted to less than or equal to 5 μm. Furthermore, when the segregation of these particles in mixing powder comes to an issue, it is preferred to use ultra-hard particles based on Co—WC having an average particle diameter of less than or equal to 70 μm, cermet particles based on Ni—TiCN or high-speed tool steel powder in which carbides such as Mo₂C and WC precipitate.

Next, the copper-based sintering sliding material according to the present invention is secondly, characterized in that one or more kind(s) of intermetallic compound that comprises two or more kinds selected from Ni, Si, Ti, Co, Fe, Al, V and P is/are dispersed, and the adding amount thereof is adjusted so that the sum of adding amounts of two or more of Ni, Si, Ti, Co, Fe, Al, V and P is 0.5 to 10% by weight.

Furthermore, the copper-based sintering sliding material according to the present invention is thirdly, characterized in that one or more kind(s) of intermetallic compound that comprises two or more kinds selected from Cu, Sn, Ca, Mn, Cr, Mo, W, Sb and Te is/are dispersed, and the adding amount thereof is in the range of 0.1 to 10% by volume in terms of intermetallic compound.

Furthermore, the copper-based sintering sliding material according to the present invention is fourthly characterized in that one or more kind(s) of intermetallic compound that comprises two or more kinds selected from Ni, Si, Ti, Co, Fe, Al, V and P is/are dispersed, and additionally one or more kind(s) of intermetallic compound that comprises two or more kinds selected from Cu, Sn, Ca, Mn, Cr, Mo, W, Sb and Te is/are dispersed, and the adding amount thereof is in the range of 0.1 to 10% by volume in terms of intermetallic compound.

It is preferred that the nonmetallic particles comprising one or more kind(s) selected from oxides, carbides, nitrides, carbonitrides and borides is/are contained in the range of 0.1% by volume, inclusive, to 4% by volume, exclusive, and the total amount thereof in terms of dispersion phase is in the range of 0.1 to 10% by volume.

Furthermore, in each aspect of the invention as described above, it is preferred that the metal and/or alloy particles comprising Mo, W, Cr, Co, Fe, Fe—C are dispersed in 0.5 to 5.0% by weight. Furthermore, it is preferred that MnS is contained in an amount of equal to or less than 1% by weight and/or graphite is contained in an amount of less than or equal to 1% by weight. In this case, it is preferred that the average particle diameter of the MnS and/or graphite is 20 to 200 μm or less.

Furthermore, in each aspect of the present invention as described above, it is preferred that at least Sn is contained in an amount of 1 to 16% by weight, and Pb is contained in an amount of 0 to 25% by weight. Furthermore, it is preferred that Sn is added in an amount of 12 to 16% by weight, and a Cu—Sn compound phase is dispersed and precipitated in the sintering sliding material structure. In this case, it is desired that one or more kind(s) of alloy element selected from Zn, Mn, Be, Mg, Ag and Bi and/or a solid lubricant such as MoS₂, CaF₂ or WS₂ is further contained.

(1) As to selection of hard first dispersion particulate material,

according to the Japanese translation of PCT publication No. 7-508799(1995) cited above, it is disclosed that by containing 5 to 40% by weight of carbides of Cr, Mo, W or V, nitrides of Al or Mo, or oxides of Cr, Ni or Zr having a particle size of 50 to 300 μm and a hardness of Hv=600 or more, for example, as appropriate hard dispersion particles, it is possible to obtain a uniform material having a friction coefficient of as high as possible, which does not particularly depend on the temperature, sliding speed and contact pressure. The selection range for hard particles can be stretched to a very wide range of compound phase if containing SiO₂, Al₂O₃, mullite and the like. To the contrary, the sliding material which is an object of the present invention is a sliding material having a friction coefficient of as small as possible in wide ranges of sliding speed and contact pressure, and having excellent abrasion resistance and seizure resistance, in particular, and mainly aims at minimizing the attacking power with respect to the counter material (iron-based material). Thus according to the present invention, from such a view point, by imparting the abrasion resistance by the scraping function of the hard first dispersion particles, and by optimizing the material quality and the adding amount thereof, a copper-based sliding material having excellent conformability, seizure resistance and abrasion resistance in both of the low-speed and high-speed sliding conditions is developed.

(1-1) Oxides, Carbides, Nitrides and Carbonitrides (Hard Nonmetallic Particles)

As described above, the scraping function of the hard first dispersion particles (nonmetallic particles) is generally considered to become significant as the hardness and size of the nonmetallic particles increase, leading significant improvement of the abrasion resistance. As will be described later, when 0.3% by weight of each of the hard particles of ZrB₂, Al₂O₃ and SiO₂ are added, the seizure resistance is poorest for the ZrB₂ (Hv=3000), and significant improvement is observed in the order of Al₂O₃ (Hv=2000) and SiO₂ (Hv=780), and the seizure resistance and the abrasion resistance will not be simply improved only by using hard first nonmetallic particles having larger hardness.

From the comparison data of addition of Al₂O₃ and SiO₂ which are different in size, it was found that as for Al₂O₃, the larger the size, the more significantly the abrasion resistance improves to thereby deteriorate the seizure resistance, however, as for addition of SiO₂, the effect of the size is not so significant. In particular, in hard particles of Al₂O₃ having a hardness of larger than or equal to that of the counter material (surface hardness in carburized and quenched steel: Hv=900), the larger the size thereof, the more significant the attacking power to the counter material, and in hard nonmetallic particles having a hardness HV of more than or equal to 1000 (e.g., Al₂O₃, TiN), it is preferred to use it while dispersing therein fine particles having an average particle diameter of less than or equal to 5 μm from the view point of reducing the attacking power to the counter material.

As for the size of hard particles, SiO₂ and ZrO₂ did not show an attacking power as significant as that observed in the Al₂O₃ even when the average particle diameter was adjusted to 20 μm. This result would attribute to the fact that these particles are not as hard as Al₂O₃, and SiO₂ in particular, shows a soft scraping function because it has a lower Young s modulus than those of the Cu alloy which is a base material and the steel which is to be a counter material. Also it would be also an important fact that these particles are superior in strength with respect to the heat shock stress which is likely to occur in the scraping function on the sliding surface as will be described later.

In a constant-speed friction abrasion test under lubrication of a sintered body of Al₂O₃ ceramics which is conducted prior to the working examples of the present invention as will be described later, the Al₂O₃ ceramics sintered body showed an extremely low seizure limit value (PV value) under a high-speed sliding condition. This would be ascribable to occurrence of destructive abrasion powder due to heat shock stress on the Al₂O₃ sliding surface. This is also apparent from Powder and Powder Metallurgy 31, p.290 (1984) by Tsukamoto, Takahashi, Komai, Hayama et al. reporting that Al₂O₃ in a friction material is destroyed by a heat shock stress.

From the facts as described above, in the present invention, we demonstrated that as the material for the above-mentioned hard first nonmetallic particles, nonmetallic particles having excellent heat shock resistance are suited as the hard dispersion particulate material of a copper-based sintering sliding material, considering that the nonmetallic particles should have an appropriate hardness of more than or equal to Hv350 because of necessity of involving the scraping function on the sliding surface as described above, as well as having excellent adhesion resistance to iron which is to be a counter material, and that the nonmetallic particles will be put under an environment where they experience such severe heat shocks of rapid heating and rapid cooling during scraping function on the sliding surface.

Therefore, in order that the nonmetallic particles have excellent heat shock resistance, at least one of the following characteristic factors should be satisfied: (1) having minimal thermal expansion coefficient; (2) having high heat conductivity; (3) having small Young s modulus; (4) having plastic deformability, and so on. It is obvious that the SiO₂ proposed in the present invention is the most suitable material considering that it exhibits a very small thermal expansion coefficient, a low Young s modulus which is less than that of the steel as described above, while having a hardness as high as that of a hardened steel as described above and exhibiting poor attacking power to the steel material. It is also obvious that as a heat shock resistant material similar to the SiO₂, Cordierite, Spodumene, Eucryptite, Al₂O₃TiO₂ and so on are effective.

It is also obvious that for the Al₂O₃ that is fragile to a heat shock stress as described above, by finely grinding into dispersion particles having a particle size of less than or equal to 5 μm, the problem of fragility can be mitigated.

Although hard dispersion particles of carbides, nitrides, carbonitrides generally have excellent heat shock resistance owing to their excellent heat conductivity, it is obvious that carbides, nitrides and carbonitrides such as WC, TiC, TiCN, Si₃N₄, TaC, HfC, ZrC, Mo₂C and VC are suited in consideration of the example of TiN addition as described later, and further in consideration of examples of the application in a cutting tool for iron-based materials. These hard dispersion particles having an average particle diameter of as small as 2 μm or less may pose a problem of uneven dispersion in a copper-based sintered sliding member from the view point of their production method. According to the present invention, since the cermet particles comprising these carbides, nitrides or carbonitrides, and Co or Ni are superior in respect of the heat shock resistance, they can be used as hard nonmetallic particles. Furthermore, the average size of the cermet particles to be added is not particularly defined, but when a problem in post-process is expected, it is preferably adjusted to less than or equal to 70 μm.

Furthermore, when the nonmetallic particles is too hard (for example, Hv=1000 or more), in order to reduce the attacking power to the counter material, the dispersion particles are grinded more finely into less than or equal to 5 μm as is described above. As for SiO₂ (Hv=780) and ZrO₂ (Hv=1050), however, since an attacking power as significant as that of Al₂O₃ was not observed even when the average particle was 20 μm, the appropriate average particle diameter for the dispersion particles having Hv=1000 or less may be about 70 μm which is a general metallurgy powder size without causing any critical problem. However, since the attacking power decreases as the particle size becomes smaller, the particle size is preferably less than or equal to 45 μm for safety, and is more preferably less than or equal to 10 μm when the dispersibility to the crystal particles of the sintering material as will be described later is taken into account.

Furthermore, addition of the nonmetallic particles generally prevents the sintering property of the copper-based sintering sliding material, and causes considerable aggregation of particles in the case of the nonmetallic particles finely grinded into less than or equal to 1 μm. Accordingly, it becomes more difficult to uniformly mix them with general metallurgy powder, so that there is a fear that the particles are continuously dispersed in the grain boundary in the sintered body, or an aggregated fragile sintered body is produced, or bondability in sinter-bonding powder mixture for these sintering sliding materials spread on the metal backing is not ensured as described above. For this reason, it is obvious that as the nonmetallic particles, using the above-mentioned cermet particles which do not require fine grinding, such as SiO₂, ZrO₂, SiO₂, Cordierite, Spodumene, Eucryptite, Al₂O₃.TiO₂ and the like are especially preferred. Furthermore, fibrous or needle-like nonmetallic particles are advantageously added in place of the fine powder from the view point of preventing the segregation and separation during mixing and spreading as described above, and Al₂O₃.TiO₂ which is easily available may be used in fibrous forms.

As for the adding amount of the above nonmetallic particles, SiO₂, Al₂O₃ particles in amount of 1.0% by weight can saturate the improving effect of the abrasion resistance, and assuming that the specific gravities of SiO₂ and Al₂O₃ are 2.2 g/cm³ and 3.9 g/cm³, and then percentages of area (% by volume) occupied by SiO₂ and Al₂O₃ in the sliding surface are about 4.0% and 2.2%, respectively, so that the improving effect of the abrasion resistance of the sliding member due to dispersion of the hard particles are already optimized at less than 4% by area (% by volume). Therefore, if the adding amount exceeds this range, the friction coefficient will needlessly increases, so that the attacking power to the counter material will be increased. Accordingly, the amount to be added to the sliding material is advisably less than 4% by volume, and preferably about 2% by volume. Furthermore, the lower limit of the adding amount is appropriately 0.2% by volume at which the improvement effect of the abrasion resistance appears more clearly.

Furthermore, as a result of research for the relationship between the matrix hardness (Hv=40 to 160) and the appropriate adding amount using different sliding materials, it was found that the higher the matrix hardness, the less the adding amount of Al₂O₃ required for expressing the above effect, fore example, and the adding amount falls within the range of 0.05 to 0.5% by weight. For example, in very soft Cu-25% by weight Pb (lead copper sintering sliding material), SiO₂ could be added in an amount of up to about 2.0% by weight, and the percentage by area of SiO₂ occupied in the sliding surface was about 8% by area. Increase in appropriate adding amount of the hard particles as described above may attribute the fact that the ability of the hard particles to scrape the adhered object of the counter material decreases in proportion to the matrix hardness. Furthermore, even in the improvement effect of the abrasion resistance of the soft matrix sliding material having a composition of Cu-25% by weight Pb, when taking the attacking power to the counter material into account, the adding amount of the hard nonmetallic particles would be optimized in the range of 0.05 to 1.0% by weight, however, when focusing on the attacking power to the counter material, it is preferred that they are used in an amount of as small as less than about 0.5% by weight. In addition, in bronze and/or lead bronze-based sintering sliding materials in which the Pb adding amount is less than or equal to 10% by weight, addition in amount of less than 0.5% by weight is more preferred.

Furthermore, in regard to the structure of the sliding material after sintering, it is not desirable that above-mentioned nonmetallic particles connect to the crystal grain boundary, and essentially it is desired that a large part of the nonmetallic particles are dispersed in the crystal particles of the copper-based sintering sliding material. Since the adding amount of the nonmetallic hard particles required in the present invention is as small as about less than 4% by volume, preferably 2% by volume (0.5% by weight in terms of SiO₂), and when the average particle diameter is less than or equal to 10 μm, a large part of the nonmetallic particles will be captured in the particles due to the growing of the particles during sintering if the sintering is executed in such a condition that allows the copper-based sintering sliding material to be sufficiently densified, so that it is obvious that the fragility will be further improved.

Furthermore, in order not to prevent the conformability of the sintering sliding material, the hardness of the sintering sliding material preferably falls within a generally same range (10% of hardness). In the present invention, since an increase of hardness due to adding the nonmetallic hard particles in an amount of 0.05 to 0.5% by weight is almost negligible, the conformability will never be prevented.

Although dispersibility of the metal particles of Mo and W was discussed as will be described later, their abilities to improve the abrasion resistance were very poor, and it was revealed that in the present invention nonmetallic hard particles are most suited as a material that is added in a small amount to a copper-based sintering sliding material and improves the abrasion resistance thereof. Furthermore, by adding the hard particles of less than 2% by volume and Mo and W together, significant effect of improving the abrasion resistance and significant effect of improving the seizure resistance were ensured.

(1-2) Intermetallic Compound

It is generally known that intermetallic compounds are much harder than metals, and have characteristics (for example, excellent heat shock resistance, plastic deformability, and the like) which are closer to those of metals than to those of the above-described oxides, carbides, nitrides and carbonitrides. With regard to this, in Powder and Powder Metallurgy 31, p.290 (1984), Tsukamoto, Takahashi, Komai, Hayama et al. discuss on the cases where various kinds of intermetallic compounds are added in large amount, for the purpose of expressing high friction coefficient in a friction material and improving the abrasion resistance in a friction material, and report that as the intermetallic compound which are suited for a friction material, those having a hardness of intermetallic compound of Hv=350 or more, and having a softening temperature of more than or equal to 400° C. are preferred. However, it is obvious that the sliding characteristics cannot be improved only from the relationship of the hardness of the intermetallic compound as is apparent from the aforementioned examples for ZrB₂, Al₂O₃.

According to the present invention, in order to achieve excellent sliding characteristics and/or abrasion resistance not only from the hardness of the intermetallic compound, but also by making the intermetallic compound itself express excellent seizure resistance, we clearly proposed, by thermodynamic approach, intermetallic compounds comprising such components that hinders automatic growing of a local adhesion, if such a local adhesion occurs between the intermetallic compound and the counter material. The present invention is characterized in that the components are selected so that the thermodynamic excessive energy when Fe and elements constituting intermetallic compound form an alloy due to adhesion at the contacting part is a large positive value, and chemically an intermetallic compound comprising elements whereby Fe element and elements constituting the intermetallic compound strongly repel with each other in the adhered alloy is used.

(1-2-1) Intermetallic Compound Comprising Two or More Kinds of Elements which thermodynamically strongly repel with Fe element.

In the case where the thermodynamic excessive energy when the Fe and the elements constituting the intermetallic compound are alloyed take a large positive value due to the local adhesion on the sliding surface, and hence the energy condition becomes unstable compared to the state before alloying (endothermic reaction), the local adhesion reaction will not automatically proceed, and the intermetallic compound which satisfies this condition is apparently superior in seizure resistance. Furthermore, elements constituting the intermetallic compound satisfying the above condition should be elements which strongly repel with the Fe atom.

An elements M which strongly repels with Fe is analyzed so that a thermodynamic interaction parameter ΩFeM between Fe and the elements in the Fe-M alloy has a large positive value, and are represented by a double-phase separation wherein Fe and M do not uniformly mingle with each other as seen in a Fe-M binary phase diagram, or in more extreme case, M is represented by a phase diagram which does not dissolve with Fe due to the repelling power between elements in Fe. More specifically, from the phase diagram of HANSEN,

1) Atoms that are known to show phase separation with respect to Fe or satisfy ΩFeM>>0 thermodynamically, examples of such elements (M) including Be, C r, Mo, W, Mn, Cu, Au, Zn, Sn, Sb, S, O and the like; and

2) Atoms which are hardly dissolved with Fe, examples of which including Pb, Bi, Ag, Li, Na, K, Mg, Ca, Rb, Sr, Ba, Cd, Te and the like, can be recited.

Therefore, adding one or more kind(s) of alloy element(s) repelling with Fe into the Cu-based sliding material which shows a clear phase separation boundary with respect to Fe in the phase diagram, to make it a copper alloy-based sintering sliding material is desirable not only from the view point of the sliding characteristics but also from the view point of the strength. Furthermore, in order to improve the strength of Cu and facilitate the sintering property, precipitating and dispersing a Cu—Sn based intermetallic compound of δ phase, β phase, γ phase and so on into a bronze-based sintering material to which a large amount of Sn has been added, will be desired from the view point of cost issue of the sintering sliding material. From the same views, it is also effective to disperse, for example, CaCu₃, Ca₂Sn, CrMn₃, Ca₃Sb₂, Ca₃Tl₄ and so on. At the same time, additionally adding alloy elements such as Zn, Be, Cr and Mn to improve the strength will be desired for the sliding material.

Since the above Mo and W are not only the elements that repel with Fe, but also the elements that strongly repel with Cu and Sn which are main components of a bronze material, they are dispersed in a bronze-based sintering sliding material as metallic particles and act so as to improve the seizure resistance of the bronze-based sintering sliding material. However, they cannot improve the abrasion resistance because they are not as hard as the aforementioned ceramics and intermetallic compound (Mo: Hv180, W: Hv120 to 350, Cr: Hv700 to 800).

Likewise, since the above Cr is also the element that strongly repels with Cu and Sn, it is dispersed in a bronze-based sintering sliding material as metallic particles, and shows higher scraping action because it has a higher hardness than Mo and W. This may lead the expectation that the abrasion resistance can be improved with less amount of addition, however, since the repelling power of Cr with respect to Fe is not as large as those of Mo and W, the improving effect of seizure resistance is apparently poor.

Therefore, from the view point of achieve the seizure resistance and abrasion resistance at once, the present invention aims at using the above hard particles, the intermetallic compound, and Cr, Mo and W particles by adding in combination, and appropriate adding amounts of Cr, Mo and W particles is larger than the adding amount of the above ceramics and intermetallic compound because the attacking power to the counter material of the Cr, Mo and W particles is small, and preferably fall in the range less than 5% by weight. More preferably, from the fact that the effect of the addition starts saturating as early as around 2% by weight, and adding a large amount will increase the cost, the adding amount is preferably in the range of 0.5 to 2.0% by weight at which the effect of addition is expressed sufficiently. In particular, when large amounts of Cr, Mo and W are added, the crystal particles of the lead bronze-based sintering sliding material are significantly miniaturized, and Pb and the above intermetallic compound of Cu—Sn is finely dispersed, so that the high-speed sliding characteristic is significantly improved, which forms one feature of the present invention.

Furthermore, the effect of miniaturizing the crystal particles can also be achieved by adding Co, Fe which are the elements that strongly repel with Cu which is a main component of a bronze material, and/or by dispersing FeCo regular phase and Fe—C alloy, and improvement of high-speed sliding characteristic of the above bronze, lead bronze-based sintering sliding materials by miniaturization of crystal particles can be expected.

Furthermore, for improving the seizure resistance with respect to iron-based counter materials for the Fe—C alloy, use of martensitic structure obtained by hardened in a cooling process after sintering or in other heat treatments is preferred.

(1-2-2) Appearance of Binary Phase Separation System by Combination of ΩFeM<<0 and Intermetallic Compound

In the above description for intermetallic compound serving as the hard nonmetallic dispersion phase, intermetallic compound comprising two or more kinds of elements repelling with Fe have been exemplified. Reversely, also in an alloy comprising a combination of two or more kinds of metals that strongly attract with iron (ΩFeM<<0) and attract with each other, it is thermodynamically confirmed proved that a binary-phase separation occurs in a ternary system Fe phase diagram. Therefore, it is obvious that by dispersing an intermetallic compound combining two or more kinds of these elements, the above adhesion resistance and the abrasion resistance are improved in the same manner as those described above.

To be more specific, as for the elements that strongly attract with Fe, in general, the phase diagram thereof often includes description that a regular phase is formed, or if such a description is not found, many of elements are known to satisfy the above ΩFeM<<0 by measurement. Examples of such elements include Al, Si, P, Sb, Ti, V, Co, Ni, Fe, Zr, Nb, Pd, Hf, Ta, Pt and the like. It is also apparent that when an intermetallic compound comprising two or more kinds of elements selected from the above examples and attracting with each other is dispersed in a copper-based sliding material, it can be used as a sliding material which is superior in adhesion resistance as is the case of the above ΩFeM>>0.

In the later examples, the relation between the dispersing and precipitating amount of the Ni—Si intermetallic compound and its sliding characteristics is clearly shown, by using high strength Cu—Ni—Sn-based sintered sliding member (Ni₃Si). In association with precipitation of the fine intermetallic compound precipitates, the adhesion resistance was improved, and by combining the ceramics-based dispersion particles, MnS and graphite, the abrasion resistance and the adhesion resistance were significantly improved, and the same effect as in the above-mentioned dispersion of metallic particles showing binary-phase separation was confirmed. Furthermore, when NiA1₃ and Ti₂P are dispersed, improvement in adhesion resistance and abrasion resistance was observed. Therefore, as a similar intermetallic compound, compounds comprising two or more kinds of Ti, V, Fe, Ni, Co, Al, Si and P can be considered. In particular, Si-based intermetallic compounds are often hard having a hardness of Hv=1000 or more, it is preferred to disperse them so that the average particle diameter is less than or equal to 5 μm.

By the way, FeCo, Fe₃Al, FeAl, FeSi, Fe₃Si and the like show a regular phase having a BCC structure, and it is obvious that these FeCo, Fe₃Al, FeAl, FeSi and Fe₃Si as well can be used with the intermetallic compound.

Furthermore, many of the above Al compounds, Ti compounds and/or P compounds (phosphides) hardly have a Vicker s hardness of higher than Hv=900, and when the steel having subjected to carburizing and quenching is used as the counter material, the attacking power does not come to a critical issue. However, as will be described later, when the counter material wears as a result of precipitation of hard Ti₂P, it is desired to compositely add a lubricant substance such as MnS and graphite as described above, as well as to first reduce the amount of Ti₂P.

Furthermore, as representative intermetallic compounds, NiAl, NiA1₃, NiTi, Ni₃Ti, CoAl, Co₃Al, TiAl, Ni₃Si, V₅A1₆, Fe₃Al, FeAl, Ti₂P (composite addition of ferrophosphorus (Fe27% P) and Ti), FeCo, FeV, Fe₂Ti, Fe₂Zr, Fe₂Nb and so on can be recited.

Among the above intermetallic compounds, there are hard compounds having a hardness of Hv=900 or higher as is the Si-based intermetallic compounds, and for these compounds, the lower limit of the adding amount is preferably set at 0.05% by weight as is the case of the above ceramics-based hard dispersion particles. Furthermore, in the NiAl (γ phase, specific gravity: 5.9 g/cm³)-based intermetallic compounds, the adding amount in the class IV high strength brass and equivalent materials is:

4% by weight<Al+Si<6% by weight

3.5% by weight<Ni+Co+Fe<6.5% by weight, and are composite intermetallic compounds (Ni, Co, Fe) (Al, Si) in these materials, so that the above intermetallic compounds may be composite intermetallic compounds wherein other alloy elements are dissolved.

In the phase of these intermetallic compounds, the hardness will not exceed Hv=900, and moreover, in the example of Si-based sintering sliding material having a composition of Cu-10% by weight and Ni-3.33% by weight, the precipitate seize of Ni₂Si in particles is as small as 2 μm or less, and the precipitation amount is about 10% by volume, and appropriately 10% by volume or less because under this the effect will be deteriorated. More preferably, since the combination of 7% by weight of Ni and 2.33% by weight of Si provides excellent sliding characteristics, the use amount is less than or equal to 10% by weight. In the same manner, as for the amount of intermetallic compound and the adding amount of the composite intermetallic compound according to the present invention, it is preferred to use the intermetallic compound while limiting the amount of the intermetallic compound to less than or equal to 10% by volume or limiting the sum of the main elements comprising the intermetallic compound to less than or equal to 10% by volume (less than or equal to 7% by volume), which is also advantageous in respect of the cost.

These intermetallic compounds may be used in the form of powder of intermetallic compound, or may be used together with powder of suitable elements as is apparent from the examples of adding Ni and Si, to allow reaction and precipitation.

Furthermore, as described above, in the present invention, in order to prevent the sintering property from deteriorating due to rapid closing of air holes, it is preferred to add powder of intermetallic compound intended for preventing the formation of air holes and formation of outflow ports due to degassing.

The regular phase of Fe₃Al containing Al of more than or equal to 5% by weight has a Vicker s hardness of Hv=300 to 350, and in the case where alloy elements such as Ni and Co are added in an amount of about 10 to 20% by weight, it can be hardened to have a hardness of as high as Hv=800 by an aging treatment at about 600° C., so that it provides a large degree of freedom as the dispersion phase and cost advantage.

(2) As for Selection of Soft Second Particle Dispersion Material

As the soft particle dispersion material, conventionally known solid lubricants such as MoS₂, WS₂ are conceived, and the mechanism to improve the sliding characteristics due to the presence of the hard particles dispersion material is based on improvement of the solid lubrication on the sliding surface which is in direct contact with the counter material during scraping action of the local adhered object by the hard particles on the sliding surface. And as a result, the attacking power to the counter material is reduced, and the seizure resistance is improved. This also expect almost the same effect as the lubricant component of the friction material as described above, and in the present invention, the adding amount is as small as less than or equal to 1% by weight in comparison to the general adding amounts as shown in the above Tables 1, 2 and 3. This is because, when a large amount of graphite is added as described above, the sintered layer becomes porous, and the fluid lubricity transits to clear boundary lubricity, so that high friction coefficient is generated. Furthermore, it is especially desirable in respect of the strength of the sintered sliding member to minimize the amount of the soft second dispersion particles which will deteriorate the strength by using a very small amount of the hard first nonmetallic particles and optimizing the size thereof.

As the above-mentioned soft particulate material having excellent solid lubricity, various solid lubricant materials described in the Solid Lubricant Hand Book are applicable, however, it is preferred not to add such soft particles as MoS₂ and WS₂ that will react with Cu during sintering the above copper-based sliding material, and the MoS₂ and WS₂ will decompose to be likely to form soft sulfides of copper. Furthermore, since the MoS₂ and WS₂ are very expensive substances, in the present invention, it is effective to coat the surface of the particles of MoS₂ and WS₂ with a reaction preventive material such as water glass or to add particles granulated from water glass or the like when these materials are used in the present invention.

Since graphite is not reactive with Cu and Sn during sintering, the coating with water glass as described above is not necessary, however, the finer the graphite particles, the more the graphite disperses continuously on the grain boundary of the sintering sliding material, significantly making the strength of the sintered body fragile, so that it is preferred to use graphite particles that are grinded to the size of more than or equal to 0.02 mm, or to use granulated graphite particles using the above-mentioned water glass. Furthermore, when graphite is added in such a large amount as is the above-mentioned friction material, due to the confirmed knowledge that graphite is very porous and prevents formation of an oil film under high-speed sliding oil lubrication, thereby increasing the friction coefficient, it is not preferred to add graphite in an amount larger than that is necessary in the case of the sliding materials applied in both of the low-speed and high-speed sliding conditions as in the present invention.

Additionally, when graphite is added to bronze and/or lead bronze-based sintering materials, in order to prevent sweating of Sn and Pb during sintering, it is preferred to add one or more kind(s) of elements selected from Ti, Cr, Mg, V, Zr, Mn, Ni and Co which have an excellent ability to form a intermetallic compound with Sn and Pb, and have good affinity to Sn and Pb and/or have good affinity to carbon. In particular, when Si or Al is contained in the sintering material, the wetability of the Sn and Pb becomes significant, so that it is preferable to add one or more of Ti, Cr, Mg, V, Zr, Mn, Ni and Co.

Furthermore, as a Pb-less material which exerts the conformability and sliding characteristics similar to those of the lead bronze-based sintering material to which 10% by weight of Pb is added, when MnS is used as an alternative, it is obvious that the adding amount of MnS is expected as about 5% by weight assuming that the MnS is contained in the same amount as Pb in terms of % volume by approximation (density of MnS: 5.2 g/cm³, density of Pb: 11.34 g/cm³). However, owing to improvement effect by dispersion of the above nonmetallic hard particles, the adding amount of 1% by weight is effective enough.

In the case where a large amount of MnS is added, as is the case of the above-mentioned graphite, MnS is continuously dispersed at the grain boundary, so that the strength of the sintered body is significantly deteriorated. For this reason, it is preferred that the size of MnS powder is more than or equal to a general metallurgy powder size level (more than or equal to 0.02 mm). In addition, as a method for preventing MnS and the like from being dispersed continuously at the grind boundary, it is preferred that MnS is alloyed in advance during bronze, lead bronze and/or copper powder ingot. Furthermore, in order to prevent the sulfur attack of the above-mentioned bronze-based sintering sliding material, adding one or more alloy element(s) such as Ti, Zn, Al, Ni and Mn, and containing other alloy elements for improving the copper alloy characteristics are not beyond the scope of the present invention.

(3) Multi-Layered Sintered Sliding Member

The present invention provides a multi-layered sintered sliding member obtained by sinter-bonding the above copper-based sintering sliding material on an iron-based metal backing material. That is, the multi-layered sintered sliding member according to the present invention is characterized by sinter-bonding each of the above-mentioned copper-based sintering sliding materials on an iron-based material.

In the multi-layered sintered sliding member according to the present invention, a press-molded body of a sintering sliding material containing Sn and/or Pb is sinter-bonded to an iron-based material, and as the components of the sintered body which is sinter-bonded to the iron-based material, preferably, one or more kind(s) of element selected from Cr, Si, Al, P and Ti which have larger affinity to iron than steel and stabilize the α phase rather than the γ phase of iron is/are contained in an amount of 0.1 to 2% by weight.

Furthermore, when the powder mixture of sintering sliding material containing Sn and/or Pb is spread on a steel plate, a primary sinter-bonding is executed at a temperature of more than or equal to 810° C., and thereafter the spread sintered layer is mechanically densified for secondary sintering to be used, in order to prevent the layer of the powder mixture that is spread at the time of the above primary sinter-bonding from peeling off the steel plate due to contraction by sintering, it is preferred to contain one or more kind(s) selected from Si, Al, Ti and Cr that allow expansion of sintering layer, and/or nonmetallic particles that prevent contraction of the sintering layer. As a method of adding Sn, preferably the sintering layer at the time of the primary sintering is expanded by using powder of a Cu—Sn-based alloy containing more than or equal to 30% by weight of Sn with respect to Cu and/or Sn raw powder.

As for the method of sinter-bonding the copper-based pressure-molded body on the steel, those disclosed in Japanese Patent Laid-Open No. 10-1704(1998) which is proposed by the present applicant can be used. According to the art disclosed in this publication, by containing 0.2 to 3.0% by weight of Ti in copper, lead, bronze, and lead bronze-based sintering sliding materials, the sinter-bondability with respect to the steel and the sliding characteristics are improved.

By the way, a problem is known that in machining the copper-based sintering material, the abrasion of the tool is accelerated, and in order to reduce such abrasion of the tool, novel selection of elements which promotes the sinter-bondability is requested.

In the present invention, the influence of various kinds of alloy elements during sinter-bonding of the pressed-powder molded body to the steel was examined in greater detail, and alloy elements 1) capable of exhibiting stable sinter-bondability even in sinter-bonding of large area such that a sintering material is sinter-bonded on the bottom surface of the hydraulic pump or cylinder block of motor as will be later, and 2) causing less abrasion in the tool at the time of machining, were selected.

The greatest problem in stably sinter-bonding the bronze-based powder as described above is to uptake various gases occurring from the sintering material. In the course of increasing the density while causing the Cu—Sn system liquid phase to appear, generation of gas due to the appearance of liquid phase at a temperature zone of, in particular, about 700° C. or higher, expansion of the sintered body due to the uptaking of the gas due to densification of moderate degree, and a densification preventing phenomenon due to clogging of the Sn outflow pores, for example, constitute important factors of preventing the sinter-bonding. However, by dispersing the ceramics particles as described above, it is possible to prevent the air holes within the sintered body from being closed due to the rapid contraction at the time of sintering. Furthermore, in the present invention, in order to ensure the gas permeability for the rapid generation of the gas due to generation of the liquid phase, elements having strong reducing power, and allowing the sintered body to expand at a temperature of 700 to 850° C. where generation of liquid phase is rapid, thereby forming the air holes for the above gas. More specifically, by adding each of the elements selected from Ti, Cr, Fe, FeP (ferrophosphorus), Si and Al, the above-mentioned densification preventing phenomenon is avoided, and as for the liquid phase that is involved in bonding during the sinter-bonding, an adding amount of Sn is set at 1 to 15% by weight by way of addition of Sn in the form of Cu—Sn-based alloy. Furthermore as for sinter-bonding temperature, in order to ensure the bondability, the sintered body that has been expanded is densified at a temperature of 700° C. or higher, and in order to prevent occurrence of insufficient bonding due to the sinter-bonding, the sinter-bonding temperature is set at least higher than or equal to the peritectic crystallization temperature (about 800° C.) of the Cu—Sn binary alloy.

Furthermore, it is obvious that the above Ti, Cr, Fe, FeP (ferrophosphorus), Si and Al which improve the sinter-bondability are also superior in adhesivity to iron, while acting as a ferrite generating element with respect to the steel, and that its function to eliminate or reduce the transformation expandability of the steel due to cooling the steel side of the sinter-bonding plane realizes such a stable sinter-bondability. In this connection, also Sn in bronze is an element that stabilizes the ferrite phase with respect to the steel, however since it has a property of repelling with iron, and is difficult to diffuse and penetrate into the steel, Sn is not effective for formation of a ferrite phase at the sinter-bonding interface. From the same view point, it is obvious that Co, V, Zr and the like have the same effect and they are included in the scope of the present invention.

Furthermore, as for addition of Ti, Cr, Si, Al and the like, raw powder of such elements or powder of mother alloys or intermetallic compounds (for example, NiAl, NiTi, CoAl, Ni₂Si) including such elements may be used.

In multi-layered sintered members such as wound bushing and engine metal which is produced by sinter-bonding powder of said bronze-based and lead bronze-based sintering material spread on a steel plate, when mixed powder composing of the bronze and/or lead bronze sintering sliding material is spread on a steel plate, sinter-bonded (primary sinter-bonding) at a temperature of higher than or equal to 810° C., and then this spread sintered layer is mechanically densified and re-sintered (secondary sintering) for use, in order to address the problem that layer of the mixed powder spread in the primary sintering peels off the steel plate due to contraction by sintering, by adding one or more kind(s) selected from elements which cause the sintered layer to expand such as Si, Al, Ti and Cr and/or nonmetallic particles that prevent the sintered layer from contracting (oxides, carbides, nitrides, solid lubricants), the present production method is enabled to be applied even in bronze-based sintered sliding members not containing Pb which is a metal having extremely low melting point.

Furthermore, in order to prevent the contraction by sintering of the spread layer having a composition of bronze-based sintering sliding material, we examined the manner of adding Sn, and by blending Cu—Sn-based alloy powder containing at least more than or equal to Cu30% by weight Sn of Sn and/or Sn raw powder, these powder which is to be a source for Sn first melts at the time of primary sintering, and reacts with the surrounding Cu and/or Cu—Sn-based alloy powder of 12% by weight Sn or less, the sintered spread layer is made expand while allowing formation of β, γ, ζ, δ, ε, η phases (see HANSEN s Cu—Sn binary phase diagram), whereby the sinter-bondability is ensured more efficiently.

### BRIEF DESCRIPTION OF THE DRAWINGS

FIG. 1 is a view showing a shape of a molded body for tensile test piece;

FIG. 2 is a graph of test results showing tensile strength of CuNiSi and CuSnNiSi sintered members;

FIGS. 3(a), 3(b), 3(c) and 3(d) are pictures of metal constitution of Cu—Ni—Si-based sintered body;

FIG. 4 is a picture of metal constitution of Cu-3Ni-1Si-0.5SiO₂ sintered body;

FIG. 5 is a view showing a shape of a sliding test piece for abrasion test at constant-speed friction;

FIG. 6 is a picture of metal constitution of Cu-10Sn-10Ni-0.55FeP-3Pb (B16) sintered body;

FIG. 7 is a view showing a shape of a test piece for sinter-bonding test; and

FIG. 8 is a view showing shapes of cylinder block/valve plate subjected to a duration test.

### DESCRIPTION OF THE PREFERRED EMBODIMENTS

Next, concrete examples for the copper-based sintering sliding material and multi-layered sintered sliding member according to the present invention will be described with reference to the drawings.

### EXAMPLE 1

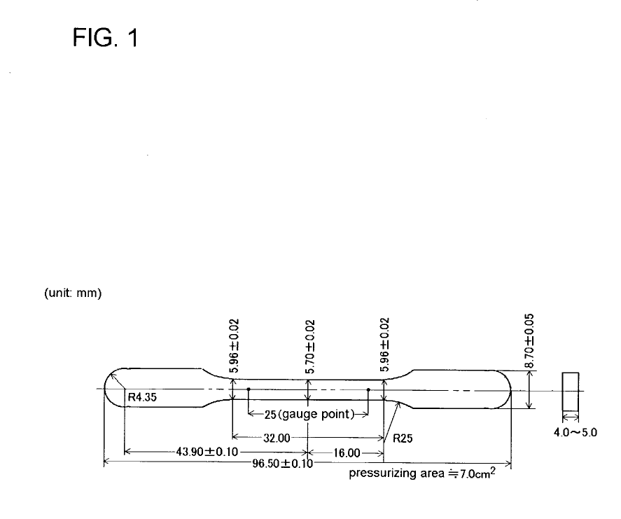

Using electrolytic Cu powder (CE25, CE15), Si, TiH powder of #300 mesh or less, ferrophosphorus (Fe25% by weight P), NiA1₃, Ni, Fe powder having an average particle diameter of 5 μm, Fe 48% by weight Co powder having an average particle diameter of 9.8 μm, SiO₂ having an average particle diameter of 21 μm, zircon sand (ZrO₂SiO₂) powder having an average particle diameter of 23 μm, Al₂O₃ powder having an average particle diameter of respectively 2 μm and 24 μm (Al₂O₃-1, Al₂O₃-2), ZrB₂, W, Mo, TiN powder having an average particle diameter of 1 μm, MnS having an average particle diameter of 1.2 μm and synthetic graphite (SGO) powder having an average particle diameter of 50 μm, different kinds of mixed powder listed in Table 4 were prepared, and after forming molded bodies at a molding pressure of 2 to 5 ton/cm², each molded body was sintered in an atmosphere of AX gas (ammonium cracked gas) having a dew point of less than or equal to −35° C. The sintered body based on the CuNiSi ternary system in Table 4 is basically produced by blending Ni and Si in a ratio of Ni:Si=3:1 by weight, for increasing the strength by precipitation of Ni₂Si-based intermetallic compounds. In order to examine the strength after sintering, each mixed powder was sinter-molded into a shape for tensile test shown in FIG. 1 and a tensile test was conducted.

TABLE 4

| symbol | CE25 | Ni | Si | ZrB₂ | Al₂O₃-1 | Al₂O₃-2 | FeP | SGO | MnS | Mo | W | SiO₂ |
|---|---|---|---|---|---|---|---|---|---|---|---|---|
| A1 | Bal. | 1.5 | 0.5 | | | | | | | | | |
| A2 | Bal. | 1.5 | 0.5 | 0.3 | | | | | | | | |
| A3 | Bal. | 1.5 | 0.5 | | 0.3 | | | | | | | |
| A4 | Bal. | 1.5 | 0.5 | | | 0.3 | | | | | | |
| A5 | Bal. | 1.5 | 0.5 | | | | 1.5 | | | | | |
| A6 | Bal. | 1.5 | 0.5 | 0.3 | | | 1.5 | | | | | |
| A7 | Bal. | 1.5 | 0.5 | | 0.3 | | 1.5 | | | | | |
| A8 | Bal. | 1.5 | 0.5 | | 0.3 | | | 0.75 | | | | |
| A9 | Bal. | 1.5 | 0.5 | | 0.3 | | | | 1 | | | |
| A10 | Bal. | 1.5 | 0.5 | | 0.3 | | 1.5 | 0.75 | | | | |
| A11 | Bal. | 1.5 | 0.5 | | 0.3 | | 1.5 | | 1 | | | |
| A12 | Bal. | 2.25 | 0.75 | | | | | | | | | |
| A13 | Bal. | 2.25 | 0.75 | 0.3 | | | | | | | | |
| A14 | Bal. | 3 | 1 | | | | | | | | | |
| A15 | Bal. | 3 | 1 | 0.3 | | | | | | | | |
| A16 | Bal. | 3 | 1 | | 0.5 | | | | | | | |
| A17 | Bal. | 3 | 1 | | 0.7 | | | | | | | |
| A18 | Bal. | 3 | 1 | | | 0.5 | | | | | | |
| A19 | Bal. | 3 | 1 | | | | | | | 1 | | |
| A20 | Bal. | 3 | 1 | | | | | | | 2 | | |
| A21 | Bal. | 3 | 1 | | | | | | | | 1 | |
| A22 | Bal. | 3 | 1 | | | | | | | | 2 | |
| A23 | Bal. | 3 | 1 | | | | | | | | | 0.5 |
| A24 | Bal. | 3 | 1 | | | | | | | | | 1 |
| A25 | Bal. | 3 | 1.75 | | | | | | | | | |
| A26 | Bal. | 3 | | | | | | | | | | |
| A27 | Bal. | 3 | 1 | | | | | | | | | |
| A28 | Bal. | 4.5 | 1.5 | | | | | | | | | |
| A29 | Bal. | 6 | 2 | | | | | | | | | |
| A30 | Bal. | 10 | 3.33 | | | | | | | | | |
| A31 | Bal. | 10 | 3.33 | | | | | | | | 1 | |
| A32 | Bal. | 10 | 3.33 | | | | | | | | | 0.5 |
| A33 | Bal. | 4.5 | | | | | | | | | | |
| A34 | Bal. | 2 | | | | | | | | | | |
| A35 | Bal. | 3 | 1 | | | | | | | | | |
| A36 | Bal. | 3 | 1 | | | | | | | | | |
| A37 | Bal. | 3 | 1 | | | | | | | | | |
| comparative | P31C | | | | | | | | | | | |
| example 1 | | | | | | | | | | | | |
| comparative | Al₂O₃ | | | | | | | | | | | |
| example 2 | | | | | | | | | | | | |
| comparative | ZrO₂ | | | | | | | | | | | |
| example 3 | | | | | | | | | | | | |
| comparative | SiO₂ | | | | | | | | | | | |
| example 4 | | | | | | | | | | | | |
| comparative | SiC | | | | | | | | | | | |
| example 5 | | | | | | | | | | | | |
| comparative | Si₃N₄ | | | | | | | | | | | |
| example 6 | | | | | | | | | | | | |

| | | | | | | | PV | |
|---|---|---|---|---|---|---|---|---|
| symbol | FeCo | Fe | TiH | NiAl₃ | ZrO₂SiO₂ | TiN | value | ΔWmm |
| A1 | | | | | | | 3000 | 0.19 |
| A2 | | | | | | | 1500 | 0.15 |
| A3 | | | | | | | 4000 | 0.02 |
| A4 | | | | | | | 1500 | 0.19 |
| A5 | | | | | | | 4000 | 0.08 |
| A6 | | | | | | | 3500 | 0.13 |
| A7 | | | | | | | 3000 | 0.32 |
| A8 | | | | | | | 4000 | 0.02 |
| A9 | | | | | | | 4500 | 0.01 |
| A10 | | | | | | | 1000 | 0.02 |
| A11 | | | | | | | 2000 | 0.02 |
| A12 | | | | | | | 4000 | 0.082 |
| A13 | | | | | | | 3000 | 0.14 |
| A14 | | | | | | | 4500 | 0.09 |
| A15 | | | | | | | 3000 | 0.12 |
| A16 | | | | | | | 5000 | 0.04 |
| A17 | | | | | | | 3000 | 0.11 |
| A18 | | | | | | | 2500 | 0.16 |
| A19 | | | | | | | 6000 | 0.1 |
| A20 | | | | | | | 7000 | 0.12 |
| A21 | | | | | | | 6000 | 0.09 |
| A22 | | | | | | | 5500 | 0.07 |
| A23 | | | | | | | 6000 | 0.02 |
| A24 | | | | | | | 4000 | 0.045 |
| A25 | | 1.5 | | | | | 6500 | 0.09 |
| A26 | | | 1 | | | | 5000 | 0.08 |
| A27 | 5 | | | | | | 7000 | 0.13 |
| A28 | | | | | | | 6000 | 0.214 |
| A29 | | | | | | | 7000 | 0.265 |
| A30 | | | | | | | 5000 | 0.392 |
| A31 | | | | | | | 4000 | 0.241 |
| A32 | | | | | | | 4000 | 0.075 |
| A33 | | | 1.5 | | | | 6500 | 0.06 |
| A34 | | | | 3 | | | 6000 | 0.06 |
| A35 | | | | | 0.5 | | 4500 | 0.07 |
| A36 | | | | | 1 | | 5000 | 0.042 |
| A37 | | | | | | 0.5 | 7000 | 0.052 |
| comparative | | | | | | | 5000 | 0.361 |
| example 1 | | | | | | | | |
| comparative | | | | | | | 1600 | — |
| example 2 | | | | | | | | |
| comparative | | | | | | | 2400 | — |
| example 3 | | | | | | | | |
| comparative | | | | | | | 3600 | — |
| example 4 | | | | | | | | |
| comparative | | | | | | | 3200 | — |
| example 5 | | | | | | | | |
| comparative | | | | | | | 2800 | — |
| example 6 | | | | | | | | |

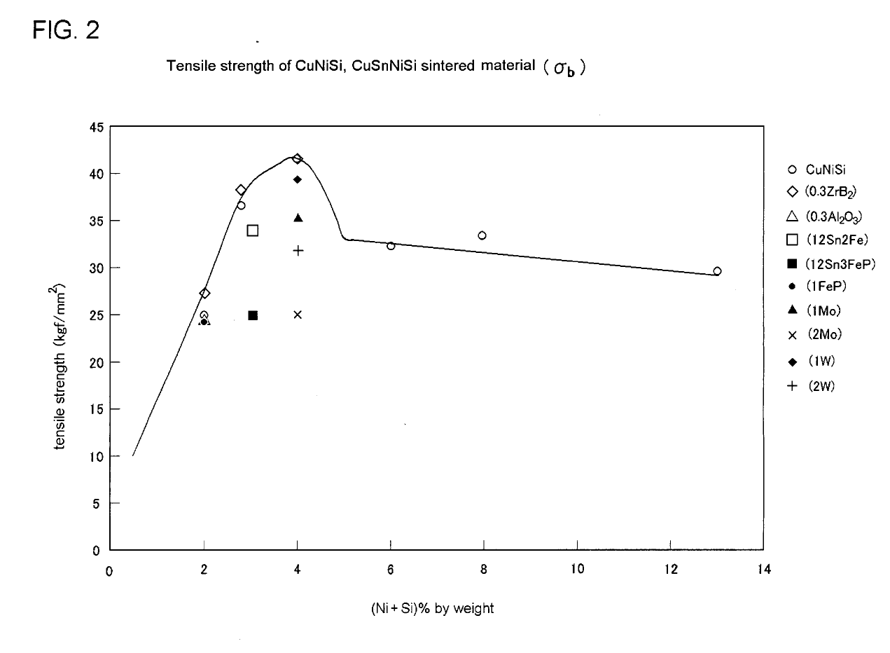

FIG. 2 shows the test result of the above tensile test. As is apparent from the graph shown in FIG. 2, the strength (tensile strength) of sintered body peaks at about 4% by weight (Ni+Si). However, at larger adding amounts, as seen from the picture of structure, a fine Ni₂Si compound is precipitated in the sintering material, and as the amount of (Ni+Si) increases, a larger intermetallic compound is precipitated at the grain boundary, so that the strength is decreased. Furthermore, from these FIG. 2 and Table 4, it can be found that when the hard particles such as ZrO₂, SiO₂, Al₂O₃-1, ferrophosphorus (Fe25P), Fe, Mo, W and the like are added in an amount of about 2% by weight or less, the strength is not considerably decreased. However, the significant decrease in strength when 1% by weight of soft MnS (density: 5.23, 1.7% by volume) was added was very problematic (comparison between No. A3 and No. A9, No. A7 and No. A11 in Table). However, it was found that when graphite (SGO) having an average particle diameter of as large as 50 μm is used as soft particles in stead of the above, and this graphite is added in an amount of 0.75% by weight (density: 2.0, 3.3% by volume), it is possible to reduce the decrease in strength (comparison between No. A3 and No. A8, No. A7 and No. A10 in Table 4). Therefore, it is obvious that use of macro particles (for example granulation) of MnS is also preferable.

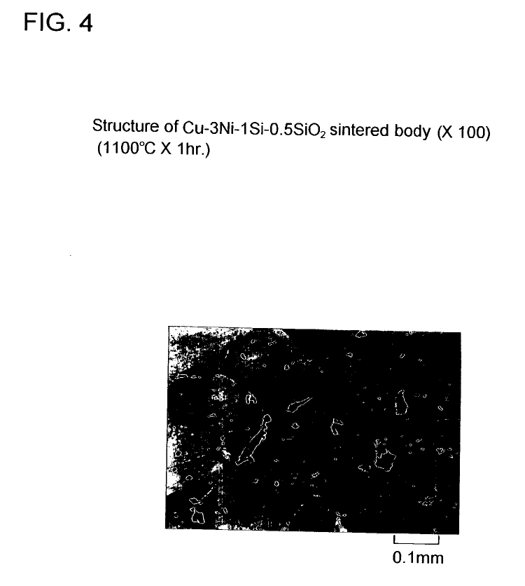

In FIG. 4 showing a picture of the structure of No. A23 in Table 4, SiO₂ particles having a particle size of 10 μm or less are taken into the matrix and dispersed therein due to the movement of the grain boundary during sintering, whereas a great part of SiO₂ particles having a size larger than the above are dispersed in the grain boundary. Therefore, apparently it is possible to prevent the strength of the sintered body from deteriorating by adjusting so that a great part of SiO₂ particles have a size of 10 μm or less. It is also obvious that as a component base of a high strength copper-based sintering material which is similar to the above CuNiSi-based, CuNiTi, CuTiSi, CuNiAl-based may be used as a base, and in such a case, the adding ratios of Ni:Ti, Ti:Si and Ni:Al are preferably about 4:1 to 3:1.

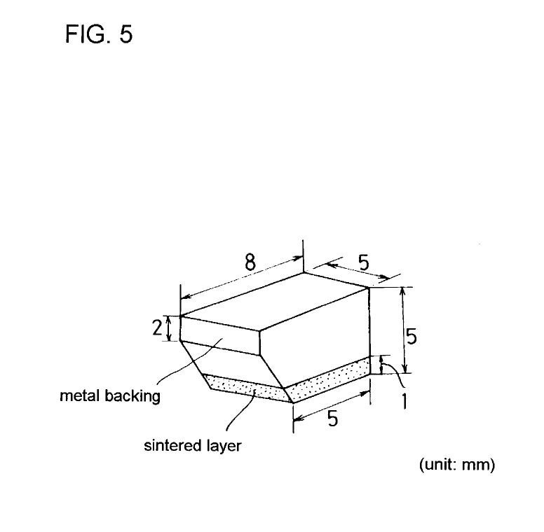

Next, in order to examine sliding characteristics of the above copper-based sintering materials, a constant-speed constant-friction abrasion test was conducted by using a sliding test piece as illustrated in FIG. 5, and determined a PV value represented by the product of a pushing pressure (kgf/cm²) of the test piece and the sliding speed (m/sec) at the point of time when the friction coefficient rapidly increases or rapid abnormal abrasion is observed, and an abrasion amount of test piece ΔW (mm). The result of this examination is also shown in Table 4. As for the test condition, a material that is prepared by subjecting SCM420 to the heat treatments of carburizing, quenching and tempering so that the surface hardness becomes Rockwell hardness of HRC60 is used as the counter material, and the counter material is rotated so that the sliding speed is 10 m/sec while supplying with a lubrication oil of #10 at 80° C. at a speed of 100 cc/min, and a 10-min. test for the test piece was repeated until the limiting condition is reached, and the PV value and the abrasion amount of the test piece specific to each sliding material was examined.

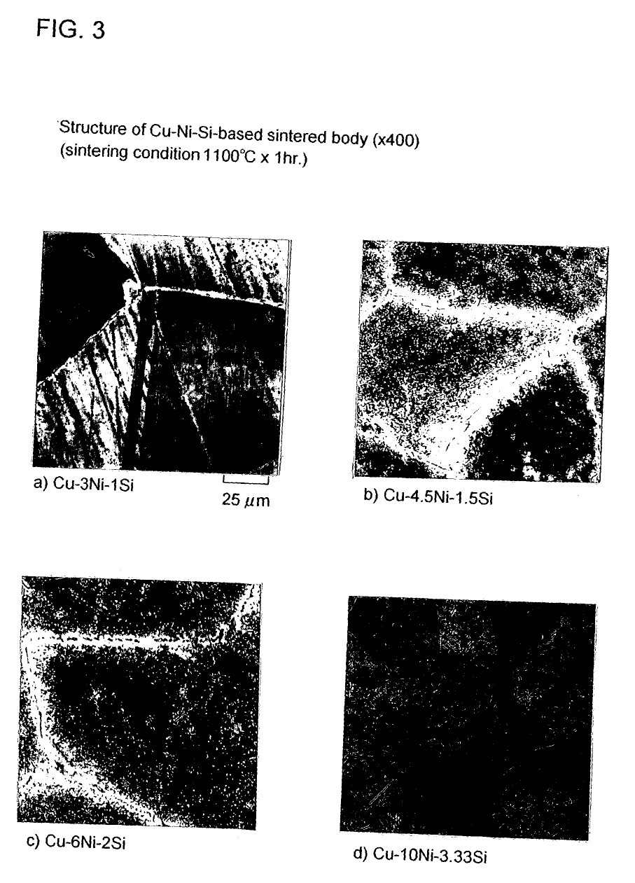

From the comparison of the sliding characteristics (PV value) of the CuNiSi ternary base materials (No. A1, A12, A14, A28 to A30), it was found that the PV value is significantly improved from Ni+Si=4% by weight, and reached maximum at Ni+Si=9.33% by weight, and then the PV value gradually deteriorates in larger adding amounts. As is apparent from the structure of the sintered body shown in FIG. 3, in this change, by adding more than or equal to Ni+Si=4% by weight, ultra fine NiSi intermetallic compound starts precipitating in the sintered body, so that significant improvement of PV value is achieved, whereas by adding Ni+Si=13.3, very bulky intermetallic compound starts precipitating at the grain boundary, so that deterioration of PV value occurs. Furthermore, since the volume percentage of the intermetallic compound reaches 100% at Ni+Si=100% by weight, Ni+Si=13.33 is approximately equal to about 10% by volume, and hence as the dispersion volume of the NiSi-based intermetallic compound, less than or equal to 10% by volume is preferred. Furthermore, using by limiting to less than or equal to 6% by volume corresponding to Ni+Si=9.33% by weight is preferable for preventing a large amount of bulky intermetallic compound from precipitating at the grain boundary.

Furthermore, the effect of Al₂O₃ as the hard particles was examined. By adding fine Al₂O₃ (Al₂O₃-1), improvement of abrasion resistance was observed while eliminating the deterioration in PV value. However, when it was added in an amount larger or equal to 0.5% by weight, PV value was deteriorated. In addition, in the case of bulky Al₂O₃ (Al₂O₃-2), addition of only 0.3% by weight resulted in deterioration of PV value. Furthermore, in the case where Al₂O₃-1 exists together with graphite (SGO) or solid lubricants such as MnS, significant improvement was observed in respect of PV value and abrasion resistance.

Also effects of addition of SiO₂ particles and ZrO₂SiO₂ are shown for No. A23, A24, A35 and A36. These particles improve the PV value and abrasion resistance up to 1.0% by weight even if they are bulky particles, and in particular, SiO₂ showed significant improvement effect at 0.5% by weight. Furthermore, even with such bulky particles, the attacking power to the counter material was little detected.

The effect of addition of TiN particles is shown for No. A37, and significant improving effect of sliding characteristics is confirmed.

Furthermore, the effects of adding Mo, W and Fe are shown for No. A19 to A22 and A25, and very significant improvement of PV value is observed. Since metallic particles of Mo, W are not originally hard particles, it can be seen the effect of improving the abrasion resistance is small. To the contrary, metallic particles of Fe partly react with Si in the CuNiSi base to form a hard FeSi-based intermetallic compound, so that the abrasion resistance is improved. In No. A27, FeCo regular alloy powder is added in place of Fe, and almost the same improving effect of PV value and abrasion resistance was confirmed. Furthermore, when hard martensite-structured Fe—C alloy is dispersed, significant improvement of abrasion resistance can be apparently expected.

As the high strength copper-based sintered member similar to the CuNiSi-based, results CuNiTi, CuNiAl-based are shown in No. A26, A33, A34, and excellent sliding characteristics comparable to that of the CuNiSi-based is confirmed.

Furthermore, as a comparative example for the high strength sliding material, there is shown a sliding characteristic of P31C (Comparative example 1:Cu28Zn3Ni4Al1Si0.7Fe 0.6Co) which is a high strength casted material having excellent abrasion resistance wherein a large amount of intermetallic compound is dispersed in a hard matrix where the α phase and the β phase are mixed. It can be recognized that the high strength copper-based sintering sliding material of the present invention exhibits much better characteristics in comparison to this comparative material. In this comparative example 1, the analysis result of EPMA (X-ray micro analyzer analysis) of the dispersing intermetallic compound is shown in Table 5. The intermetallic compound in this P31C material is a composite intermetallic compound of (Ni, Co, Fe) (Al, Si) wherein two kinds, Al-rich and Si-rich are dispersed, and in an Al-rich intermetallic compound, Ni is contained in a larger amount, and in a Si-rich intermetallic compound, Fe, Co is contained in a larger amount.

TABLE 5
Chemical composition of intermetallic compound dispersing
in sintered structure of P31C (mol %)

| Ni | Co | Fe | Cu | Al | Si | Zn |
|---|---|---|---|---|---|---|
| 22.6 | 14.7 | 15.8 | 6.5 | 22.4 | 15.2 | 2.8 |
| 31.6 | 9.06 | 6.16 | 8.87 | 31.4 | 9.13 | 3.76 |

From this result, the poor abrasion resistance in Comparative example 1 can be considered as resulting from that the matrix of P31C is easy to adhere, however, it is impossible to deny the possibility that the above poor abrasion resistant results from the fact that present invention deals with a sintering sliding material including air holes with slight oil-bearing capability.

Also the sliding characteristics (PV value) of ceramics materials such as A1₂O₃ (Comparative example 2), ZrO₂ (Comparative example 3), SiO₂ (Comparative example 4), SiC (Comparative example 5), Si₃N₄ (Comparative example 6) and the like were examined using sliding test pieces which are finished to have a surface roughness of Rmax=1 μm or less. As shown in Table 4, in the high sliding speed condition (10 m/sec), the sliding characteristics were not as excellent as expected, however, it can be realized that material having higher heat shock resistance are more preferred. In particular, as to Al₂O₃, the surface roughness after the sliding test was deteriorated to Rmax of 5 to 15 μm, and a clear chipping due to heat shock was observed on the sliding surface, which reveals strong attacking power to the counter material. In a condition that the sliding speed is less than or equal to 2.5 m/sec, and hence a heat shock load is not likely to be applied due to local adhesion, seizure was not observed even at the maximum bearing of 800 kgf/cm², so that sliding with small friction coefficient was confirmed.

### EXAMPLE 2

In this example, examination was made for the CuSn bronze-based sintering sliding materials to which 3% by weight at maximum of lead was added. The sintering sliding materials used in Example 2 were produced in the manner as follows. Various kinds of mixed powder listed in Table 6 were prepared using Sn, Pb, Al of #250 mesh or less, carbide, Cu30% by weight Zn and Cr, Mn, MnSi, TiSi of #300 mesh or less in addition to the raw material powder used in Example 1, and molded bodies were formed at a molding pressure of 2 ton/cm², and thereafter each molded body was sintered in an atmosphere of AX gas (ammonium cracked gas) having a dew point of less than or equal to −35° C. The sintering temperature was in the range of 850 to 900° C. depending on the component base. Sliding characteristics (PV value, ΔW) evaluated in the same manner as Example 1 are also shown in Table 6.

TABLE 6

| | | | | | | | | | | | | | | | | | | | PV | |
|---|---|---|---|---|---|---|---|---|---|---|---|---|---|---|---|---|---|---|---|---|
| symbol | CE15 | Sn | Pb | FeP | TiH | Ni | Si | Al | Zn | SiO₂ | NiAl₃ | Mn | Fe | Co | MnSi | TiSi | carbide | Cr | value | ΔWmm |
| B1 | Bal. | 10 | | 0 | | | | | | | | | | | | | | | 5000 | 0.19 |
| B2 | Bal. | 10 | 3 | 0 | | | | | | | | | | | | | | | 8000 | 0.24 |
| B3 | Bal. | 10 | 3 | 0.55 | | | | | | | | | | | | | | | 8000 | 0.09 |
| B4 | Bal. | 10 | 3 | 1.5 | | | | | | | | | | | | | | | 6500 | 0.02 |
| B5 | Bal. | 10 | 3 | 3 | | | | | | | | | | | | | | | 3000 | 0.08 |
| B6 | Bal. | 10 | 3 | | 2 | | | | | | | | | | | | | | 8000 | 0.05 |
| B7 | Bal. | 10 | 3 | 1.5 | 2 | | | | | | | | | | | | | | 7500 | 0.01 |
| B8 | Bal. | 10 | 3 | 3 | 2 | | | | | | | | | | | | | | 4500 | 0.06 |
| B9 | Bal. | 10 | 3 | | 0.65 | 2.4 | | | | | | | | | | | | | 5500 | 0.03 |
| B10 | Bal. | 10 | 3 | | 1.1 | | 0.4 | | | | | | | | | | | | 5000 | 0.02 |
| B11 | Bal. | 10 | 3 | 3 | 1.1 | | 0.4 | | | | | | | | | | | | 3500 | 0.09 |
| B12 | Bal. | 10 | 3 | | 3 | | | 2 | | | | | | | | | | | 6500 | 0.08 |
| B13 | Bal. | 10 | 3 | 3 | | 3 | 1 | | | | | | | | | | | | 4000 | 0.03 |
| B14 | Bal. | 10 | 3 | | | 3 | 1 | | | | | | | | | | | | 8000 | 0.09 |
| B15 | Bal. | 10 | 3 | | | 4.5 | 1.5 | | | | | | | | | | | | 7000 | 0.17 |
| B16 | Bal. | 10 | 3 | 0.55 | | 10 | | | | | | | | | | | | | 6000 | 0.04 |
| B17 | Bal. | 10 | 3 | 0.55 | | 20 | | | | | | | | | | | | | 4500 | 0.08 |
| B18 | Bal. | 5 | 3 | 0.55 | | | | | 15 | | | | | | | | | | 5500 | 0.08 |
| B19 | Bal. | 5 | 3 | | | 3 | 1 | | 15 | | | | | | | | | | 6000 | 0.06 |
| B20 | Bal. | 5 | 3 | 0.55 | | | | | 21 | | | | | | | | | | 6000 | 0.06 |
| B21 | Bal. | 5 | 3 | | | 3 | 1 | | 21 | | | | | | | | | | 8500 | 0.02 |
| B22 | Bal. | 14 | 3 | 0.55 | | | | | | | | | | | | | | | 7000 | 0.11 |
| B23 | Bal. | 16 | 3 | 0.55 | | | | | | | | | | | | | | | 6000 | 0.09 |
| B24 | Bal. | 10 | 3 | 0.55 | | | | | | 0.3 | | | | | | | | | 7000 | 0.01 |
| B25 | Bal. | 10 | 3 | | | | | | | | 1.5 | | | | | | | | 7000 | 0.02 |
| B26 | Bal. | 10 | 3 | | | | | | | | 3 | | | | | | | | 7500 | 0.02 |
| B27 | Bal. | 10 | 3 | | | | 1 | | | | | 3 | | | | | | | 3500 | 0.11 |
| B28 | Bal. | 10 | 3 | | | | | | | | | | 2 | 2 | | | | | 7000 | 0.05 |
| B29 | Bal. | 10 | 3 | | | | | | | | | | | | 1 | | | | 4000 | 0.13 |
| B30 | Bal. | 10 | 3 | | | | | | | | | | | | | 1 | | | 6500 | 0.11 |
| B31 | Bal. | 10 | 3 | | | | | | | | | | | | | | 5 | | 5500 | 0.06 |
| B32 | Bal. | 10 | 3 | | | | | | | | | | 1 | | | | 5 | | 8500 | 0.02 |
| B33 | Bal. | 10 | 3 | | | | | | | | | | | 1 | | | 5 | | 7500 | 0.04 |
| B34 | Bal. | 10 | 3 | | | | | | | | | | | | | | | 1 | 7500 | 0.12 |
| comparative | PBC | | | | | | | | | | | | | | | | | | 5000 | 0.21 |
| example 1 | | | | | | | | | | | | | | | | | | | | |
| comparative | LBC | | | | | | | | | | | | | | | | | | 5500 | 0.39 |
| example 2 | | | | | | | | | | | | | | | | | | | | |

From the results of No. B1 to B5 in Table 6, it was confirmed that ferrophosphorus significantly improves the abrasion resistance while slightly improving the PV value up to the adding amount of 1.5% by weight, however, since the PV is significantly deteriorated at 3% by weight, the appropriate adding amount of the ferrophosphorus is considered as less than 3% by weight, and about 2% by weight is preferred.

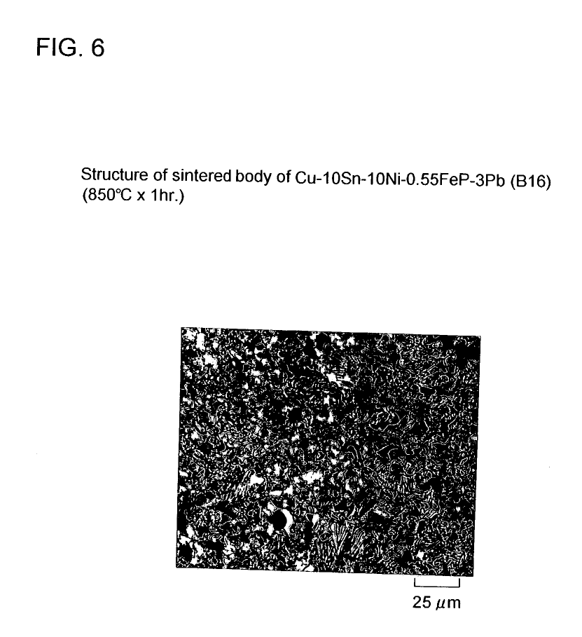

In No. B6 to B8 in FIG. 6, the effects of addition of Ti and ferrophosphorus were examined. When Ti is added alone, it allows Pb to be finely dispersed and promotes the sintering property, while uptaking nitrogen or carbon from the organic lubricant added to the mixed powder (0.7% by weight ACRAWAX C (Lonza Japan Ltd.)) from the AX environment during sintering to slightly form TiN, TiC, and this contributes to improve the abrasion resistance without deteriorating the sliding characteristics. In addition, when Ti is added together with ferrophosphorus, a great part of Ti is precipitated in the form of TiP or Ti₂P, and in the case of No. B7, almost all the P in ferrophosphorus was reacted as Ti₂P, and the remaining Ti was further dispersed in the form of Fe₂Ti in the sintered body, so that the PV value and the abrasion resistance were significantly improved. The deterioration in sliding characteristics observed in No. B8 is apparently attributable to the existence of excessive amount of ferrophosphorus.

In No. B9 to B15, the high strength elements as discussed in the above Example 1 were added in combination. When Ni is added in high concentration, the hardness of the sintered body significantly increased (about Hv=200) because of formation of the eutectoid structure due to the NiSn-based intermetallic compound as shown in FIG. 6, however, in these cases, abrasion resistance rather than PV value was significantly improved. In addition, it was confirmed that addition of high concentration of Zn does not significantly improve the PV and the abrasion resistance.

No. B22, B23 wherein CuSn intermetallic compounds are dispersed in sintering sliding materials showed clear improvement of the PV value. Furthermore, in No. B24 to B34 wherein SiO₂, NiAl₃, MnSi, FeCo, TiSi, carbide and Cr are dispersed, improvement of PV value or improvement of abrasion resistance was confirmed except for MnSi.

### EXAMPLE 3

In this example, examination was made for the bronze and lead bronze-based sintering sliding materials to which 25% by weight at maximum of lead was added. The sintering sliding materials used in Example 3 were produced in the manner as follows. Various kinds of mixed powder listed in Tables 7 and 8 were prepared using KJ4 (25% by weight Pb—Cu alloy) of #250 mesh or less in addition to the raw material powder used in Examples 1 and 2, and molded bodies were formed at a molding pressure of 2 ton/cm², and thereafter each molded body was sintered in an atmosphere of AX gas (ammonium cracked gas) having a dew point of less than or equal to −35° C. The sintering temperature was in the range of 800 to 860° C. depending on the component base.

TABLE 7

| | | | | | | | | | | | | | | | PV | |
|---|---|---|---|---|---|---|---|---|---|---|---|---|---|---|---|---|
| symbol | Cu | Sn | Pb | TiH | Ni | Si | Si0₂ | FeP | Mo | W | NiAl₃ | Fe | Co | CaF₂ | value | ΔWmm |
| C1 | Bal. | 11 | 1 | 0.15 | | | | | | | | | | | 5500 | 0.08 |
| C2 | Bal. | 11 | 3 | 0.15 | | | | | | | | | | | 6000 | 0.06 |
| C3 | Bal. | 11 | 5 | 0.15 | | | | | | | | | | | 6000 | 0.09 |
| C4 | Bal. | 11 | 8 | 0.15 | | | | | | | | | | | 6000 | 0.13 |
| C5 | Bal. | 11 | 10 | 0.15 | | | | | | | | | | | 5500 | 0.27 |
| C6 | Bal. | 11 | 10 | 1 | | | | | | | | 2 | | | 7500 | 0.04 |
| C7 | Bal. | 11 | 10 | | 3 | 1 | | | | | | | | | 7500 | 0.05 |
| C8 | Bal. | 11 | 10 | | | | 0.3 | | | | | | | | 8000 | 0.03 |
| C9 | Bal. | 11 | 10 | | | | | 1 | | | | | | | 6500 | 0.03 |
| C10 | Bal. | 11 | 10 | | | | | | 2 | | | | | | 6000 | 0.08 |
| C11 | Bal. | 11 | 10 | | | | | 1 | 2 | | | | | | 8000 | 0.02 |
| C12 | Bal. | 11 | 10 | | | | | | | 2 | | | | | 5500 | 0.08 |
| C13 | Bal. | 11 | 10 | | | | | 0.55 | | 2 | | | | | 7500 | 0.04 |
| C14 | Bal. | 11 | 10 | | | | | | | | 1.5 | | | | 8000 | 0.04 |
| C15 | Bal. | 11 | 10 | | | | | | | | 3 | | | | 7000 | 0.03 |
| C16 | Bal. | 11 | 10 | | | | | | | | | 2 | 2 | | 8000 | 0.03 |
| C17 | Bal. | 11 | 10 | | | | | | | | | | | 1 | 7500 | 0.05 |
| comparative | LBC | | | | | | | | | | | | | | 5500 | 0.358 |
| example 2 | | | | | | | | | | | | | | | | |

CE15 3.1 8 gr/cm³

TABLE 8

| symbol | Cu | Sn | Pb | Mo | W | SiO₂ | FeP | PV value | ΔWmm |
|---|---|---|---|---|---|---|---|---|---|
| D1 | Bal. | 0 | 25 | | | | | 5000* | >1.2 |
| D2 | Bal. | 0 | 25 | 2 | | | | 7000 | 0.72 |
| D3 | Bal. | 0 | 25 | 4 | | | | 7500 | 0.61 |
| D4 | Bal. | 0 | 25 | | 2 | | | 6500 | 0.75 |
| D5 | Bal. | 0 | 25 | | 4 | | | 7500 | 0.5 |
| D6 | Bal. | 0 | 25 | | | 0.3 | | 7500 | 0.37 |
| D7 | Bal. | 0 | 25 | | | 0.5 | | 7000 | 0.27 |
| D8 | Bal. | 0 | 25 | | | 1 | | 6500 | 0.18 |
| D9 | Bal. | 0 | 25 | | | | 0.55 | 6500 | 0.46 |
| D10 | Bal. | 0 | 25 | | | | 1.5 | 7500 | 0.21 |

*: Limit due to abnormal abrasion

In No. C1 to C5, effects of Pb addition to Cu-11Sn was confirmed. Pb is superior in reproducibility of PV value rather than improvement of PV value, however, it is clear that Pb significantly deteriorates the abrasion resistance. Also in the cases where either of Fe and Ti (Fe₂Ti), Ni and Si (NiSi intermetallic compound), SiO2, ferrophosphorus, Mo, W, NiAl₃ and FeCo is added, abrasion resistance was significantly improved, with the result that PV value was also improved. Among these, as can be known from the results for No. C10 to C13, since metallic particles of Mo, W can improve abrasion resistance and PV value more efficiently in the presence of hard particles such as ferrophosphorus rather than in absence of such particles, it is obvious that the improving effect of PV value by Mo, W metallic particles is achieved in the presence of hard nonmetallic particles.

In the sintering sliding materials using KJ4 as listed in Table 8, PV value and abrasion resistance are all improved compared to the sintering material (No. Dl) including only KJ4. This is possibly because the No. D1 material has very poor abrasion resistance, and hence causes abnormal abrasion until seizing occurs. In particular, even in the No. D8 material to which 1% by weight of SiO₂ is added, superior characteristics compared to the No. D1 material are observed. However, since SiO₂ addition of No. D8 level may cause appearance of attacking power to the counter material, the adding amount of SiO₂ is preferably less than 1.0% by weight.

Furthermore, the effect of dispersion of particles on the abrasion resistance was compared between Table 8 and Table 7, and the sintering materials listed in Table 8 in which the sintering raw materials are harder exhibited more significant improving effects. This clearly shows that the ability to scrape adhered objects owing to dispersion of particles is not sufficiently achieved in the soft sintering materials.

### EXAMPLE 4

In Example 4, a method for producing a multi-layered sintered sliding member by integrating a Pb-free bronze-based sintering sliding material on a metal backing steel plate (SPCC) is discussed. For the sintering sliding material used in Example 4, various kinds of mixed powder listed in Table 9 were prepared using Cu10% by weight Sn, Cu-20% by weight Sn, Cu33% by weight Sn of #250 mesh or less, in addition to the raw material powder used in Example 1, 2, and 3. For these sintering sliding materials, first powder for copper-based sintering material was spread on a metal backing in 3.5 mm thick so that the finished thickness is 0.6 mm in thick, and the spread powder was sintered at 820 to 860° C. in an RX gas atmosphere, and rolled by a rolling machine so that the total thickness of sintered layer is 0.8 mm, followed by re-sintering at 800 to 840° C. In Table 9, combinations by which peeling rather than sinter-bonding occurred during the first sintering or by which peeling occurred during rolling process are shown. Apparently, No. F1, F2 using only alloy powder and No. F3 prepared from copper powder and Cu20Sn alloy powder showed significant contraction at the sintering temperature to peel off the metal backing. As shown by No. F4 to F7, it was also found sinter-bonding becomes successful when powder having a Sn concentration of more than or equal to Cu33Sn is used. This is because in a temperature range of the peritectic crystallization temperature of Cu—Sn alloy system (about 800° C.) or lower, when Cu33Sn and Sn melt during sintering to generate a liquid phase which is essential for sinter-bonding and start reacting with Cu powder, thereby forming various CuSn intermetallic compounds such as β, γ, ζ, δ, ε or the like, expansion prevents contraction which may cause peeling.

TABLE 9

| | | | | | | | | | | | | | | | sinter- |
|---|---|---|---|---|---|---|---|---|---|---|---|---|---|---|---|
| | Cu10Sn | Cu14Sn | Cu | Cu20Sn | Cu33Sn | Sn | Cu10Sn10Pb | SiO₂-2 | Si₃N₄ | CaF₂ | SGO | Cu40Al | NiAl₃ | Cr | bondability |
| F1 | 100 | | | | | | | | | | | | | | X |
| F2 | | 100 | | | | | | | | | | | | | X |
| F3 | | | Bal. | 50 | | | | | | | | | | | X |
| F4 | | | Bal. | | 31 | | | | | | | | | | Δ2/5 |
| F5 | | | Bal. | | | 8 | | | | | | | | | ◯0/5 |
| F6 | | | Bal. | | | 11 | | 0.5 | | | | | | | ◯0/5 |
| F7 | | | Bal. | | | 14 | | | | | | | | | ◯0/5 |
| F8 | | | | | | | 100 | | | | | | | | Δ2/5 |
| F9 | | | | | | | Bal. | | 0.5 | | | | | | ◯ |
| F10 | Bal. | | | | | | | 0.5 | | | | | | | X5/5 |
| F11 | | | Bal. | | 31 | | | 0.5 | | | | | | | ◯ |
| F12 | Bal. | | | | | 4 | | | | | | | | | Δ2/5 |
| F13 | Bal. | | | | | 4 | | 0.5 | | | | | | | ◯ |
| F14 | Bal. | | | | | 4 | | | 0.5 | | | | | | ◯ |
| F15 | Bal. | | | | | 2 | | | | 1 | | | | | ◯ |
| F16 | Bal. | | | | | 2 | | | | | 1 | | | | ◯ |
| F17 | Bal. | | | | | 2 | | | | 1 | 1 | | | | ◯ |
| F18 | Bal. | | | | | | | | | | | 1 | | | ◯ |
| F19 | | Bal. | | | | | | | | | | | 2 | | ◯ |
| F20 | | | Bal. | | 31 | | | 0.5 | | | | | | 1 | ◯ |
| F21 | | | Bal. | | 31 | | | 0.3 | | | | | 1 | | ◯ |
| F22 | | | Bal. | | 31 | | | | 0.5 | | | 1 | | | ◯ |

Furthermore, from such a view point, it is very effective to add an element that actively prevents contraction of the copper-based sintered layer, and as shown in No. F10 to F22, those delaying the contraction such as SiO₂, Si₃N₄ and graphite (SGO), or elements that actively impart expansibility (Al, Si, Ti, Cr) are preferably added. In particular, when adding Al or Si alone, it is preferred to add it in the forms of alloy or intermetallic compound because of its strong reactivity with atmosphere. However, when Al, Si, Ti, Cr or the like is added in the form of raw powder, the sintering atmosphere is preferably an atmosphere which is an excellent non-oxidizing atmosphere such as AX gas atmosphere or vacuum.

Furthermore, in No. F8, F9 using LBC bronze (Cu10Sn10Pb), since a large amount of Pb having low melting point is contained, the sinter-bondability is ensured. However, for the composition of No. F8, the sintering temperature is practically in the range of 780 to 810° C., so that control of the atmosphere, oxidation degree of powder and so on is difficult, in particular, around the peritectic crystallization temperature (800° C.), and it should be done severely. In this Example, No. F8, F9 was sinter-bonded at 820° C., however, it is obvious that as for No. F8, peeling occurs due to significant contraction, and this can be significantly improved by adding a sintering preventing agent such as Si₃N₄ and the above expanding elements as described above.

Additionally, the multi-layered sintered sliding member having sinter-bonded with the above metal backing was bended in a circle having an inside diameter of 50 mm, and peeling from the metal backing and cracking of the sintered layer were examined. Then desired results were obtained in all levels. Furthermore, peeling and cracking of the sintered body were examined after subjecting the inner periphery to burnishing process following welding of the metal backing, and it was revealed that a wound bushing which is desirable in all respects can be produced.

### EXAMPLE 5

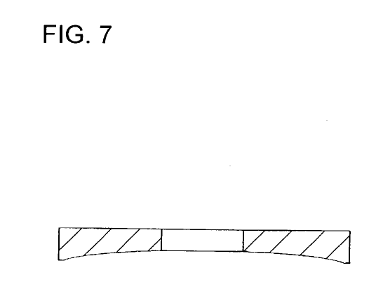

In Example 5, with respect to the steel having a shape illustrated in FIG. 7 (SCM440H), the above sintering sliding materials were sinter-bonded. The sintering sliding materials subjected to the bonding test were fabricated by molding various kinds of mixed powder listed in Table 10 prepared by blending the raw material powder described in Examples 1 to 4, at a molding pressure of 2 ton/cm². In Table 10, the sintering temperature was 860° C. for No. E1 to E17, and 1070° C. for No. E18, E19, and bonded area percentage (bondability) measured by using an ultrasonic inspection apparatus after sinter-bonding is also shown in Table 10.

TABLE 10

| symbol | Cu | Sn | Pb | Ti | Cr | V | FeP | Ni | Mo | SiO₂ | NiAl₃ | Ni₃Si | CaF₂ | Si | bondability |
|---|---|---|---|---|---|---|---|---|---|---|---|---|---|---|---|
| E1 | Bal. | 10 | 10 | | | | | 2 | | | | | | | 73.0% |
| E2 | Bal. | 10 | 10 | 0.5 | | | | | | | | | | | 97.0% |
| E3 | Bal. | 10 | 10 | 0.5 | | | 1 | 2 | | | | | | | 98.5% |
| E4 | Bal. | 10 | 10 | 0.5 | | | | | 2 | | | | | | 97.0% |
| E5 | Bal. | 10 | 10 | | 0.1 | | | 2 | | | | | | | 91.0% |
| E6 | Bal. | 10 | 10 | | 0.5 | | | | 2 | | | | | | 97.0% |
| E7 | Bal. | 10 | 10 | | 0.5 | | 1 | | 2 | | | | | | 98.0% |
| E8 | Bal. | 14 | 5 | | | | | | 2 | | | | | | 63.0% |
| E9 | Bal. | 14 | 5 | | 0.5 | | | | 2 | 0.3 | | | | | 91.0% |
| E10 | Bal. | 16 | 0 | | 0.5 | | | | 2 | | | | | | 94.0% |
| E11 | Bal. | 10 | 10 | | 0.5 | | | | | | 1.5 | | | | 99.5% |
| E12 | Bal. | 10 | 10 | | 0.5 | | 1 | | | | 1.5 | | | | 99.0% |
| E13 | Bal. | 10 | 10 | | 0.5 | | | | | 0.5 | 1.5 | | | | 99.5% |
| E14 | Bal. | 10 | 10 | | 0.5 | | | | | 0.3 | | 3 | | | 99.5% |
| E15 | Bal. | 10 | 10 | | 0.5 | | 1 | | | | | | 2 | | 98.0% |
| E16 | Bal. | 10 | 10 | | | 0.5 | | 2 | | | | | | | 95.0% |
| E17 | Bal. | 10 | 10 | | | 0.5 | | | | | 0.5 | | | | 99.0% |
| E18 | Bal. | | | | | | | 6 | | 0.3 | | | | 2 | 87.5% |
| E19 | Bal. | 1 | | | | | | 6 | | 0.3 | | | | 2 | 96.5% |
| comparative | Bal. | 11 | 10 | | | | | 2 | | | | | | | coordinate |
| example 4* | | | | | | | | | | | | | | | casting |

First from the results of No. E1, E2, E5, E6, E16, it can be seen that by adding a small amount of Ti, Cr, V, the sinter-bondability is significantly improved, and also by adding ferrophosphorus, SiO₂, CaF₂, the sinter-bondability is improved. In particular, when by adding Si, Al which is an expanding element in the form of Ni₃Si, NiA1₃ or the like, the bondability is significantly improved due to the degassing effect in the sintering process. Also since ferrophosphorus, Si, Al and the like are superior in affinity to steel to copper, and stabilize the ferrite phase of iron, a ferrite phase is formed almost uniformly in the width of more than or equal to 20 μm on the steel side of the bonding interface, so that the peeling power exerted on the bonding interface due to transformation expansion during cooling process after sinter-bonding is considerably reduced. Accordingly, they can be recognized as very preferable elements.

Furthermore, in Example 5, it was demonstrated that even in the case where Pb from Sn and Pb which constitute main components of a liquid phase at the time of sinter-bonding is not added, by adding a small amount of Cr, Si, Ti, ferrophosphorus or the like, good sinter-bondability is ensured. Furthermore, in No. E18, E19 where the sinter-bonding is executed at higher temperatures, addition of 1% by weight of Sn largely contributed to improvement of bondability, and from the bonded area percentage thereof, it was found that adding Sn in an amount of more than or equal to 1% by weight is preferred.

### EXAMPLE 6

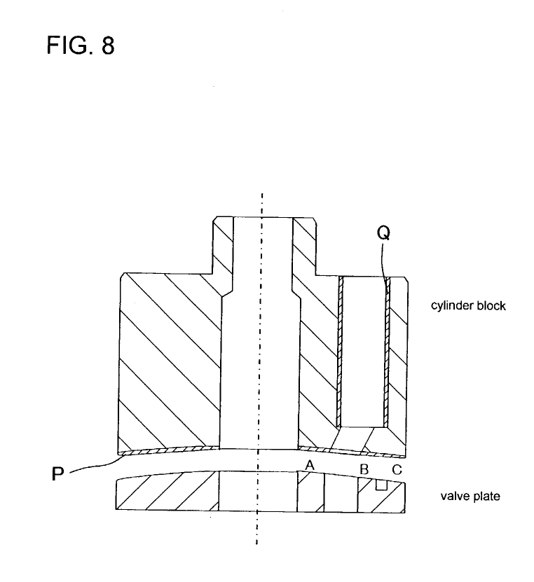

In Example 6, a representative sintering sliding material shown in Example 5 was sinter-bonded on the bottom surface P of the cylinder block bottom surface P of the hydraulic pump (our product HPV95) as shown in FIG. 8, and integrated into the hydraulic pump, and then subjected to a practical duration test. On the inner periphery of bore Q of the cylinder block, a lead bronze-based sintering sliding material having a composition of Cu-10% by weight Sn-1% by weight Ti-2% by weight NiA13-5% by weight Pb-1% by weight FeP (ferrophosphorus) was sinter-bonded to be subjected to the duration test.

The duration test was conducted by continuing operation at a revolution speed of 2300 rpm and discharge hydraulic pressure of 420 kg/cm² for 300 hr. The valve plate which is to be a counter member of the bottom surface of the cylinder block was used after subjecting a co-printing wrapping process together with the bottom surface of the cylinder block after subjecting a SCM420H member to carburizing process. In executing the co-printing wrapping, the curvature of the bottom surface was adjusted so that the contact ratio between the three sealing portions A, B, and C and cylinder block is generally A:B:C=1:1:0.2, and the cylinder block will rotate while whirling, while taking the cylinder block after long-time use into account. Then the seizure at the bore portion of the cylinder block, seizure at the bottom surface, abrasion amount, as well as seizure and abrasion amount at the valve plate were measured after continuing the operation for 50, 100 and 300 hr. The results are shown in Table 11.

TABLE 11

| | | seizure at | abrasion | abrasion |
|---|---|---|---|---|
| | test time (hr) | bottom surface | amount (μm) | amount (μm) |
| E2 | 50 | X | 17 | 5 |
| E3 | 50 | ◯ | 5 | 4 |
| | 100 | X | 7 | 6 |
| E4 | 50 | X | 14 | 3 |
| E6 | 50 | ◯ | 7 | 3 |
| | 100 | X | 16 | 4 |
| E7 | 50 | ◯ | 5 | 2 |
| | 100 | ◯ | 6 | 3 |
| | 300 | ◯ | 9 | 6 |
| E10 | 50 | ◯ | 9 | 3 |
| | 100 | ◯ | 12 | 6 |
| | 300 | ◯ | 18 | 9 |
| E11 | 50 | ◯ | 5 | 3 |
| | 100 | ◯ | 7 | 4 |
| | 300 | X | 12 | 8 |
| E12 | 50 | ◯ | 5 | 3 |
| | 100 | ◯ | 6 | 5 |
| | 300 | ◯ | 9 | 8 |
| E13 | 50 | ◯ | 2 | 5 |
| | 100 | ◯ | 3 | 9 |
| | 300 | ◯ | 5 | 15 |
| comparative | 50 | ◯ | 14 | 3 |
| example 4 | 100 | X | 26 | 5 |

This result revealed that the sliding materials in which nonmetallic particles of the material of the present invention show considerably excellent durability compared to the Comparative example 4 and No. E2, E4. In particular, in high sliding speed condition associated with vibration, improvement of abrasion resistance by dispersing hard particles is inevitable, and in comparing No. E4, E6, E7, for example, by adding Mo and nonmetallic particles together, both seizure resistance and abrasion resistance are significantly improved. Furthermore, from the example of No. E13, it can be seen that addition of SiO₂ is effective for improving the abrasion resistance, but it shows a little bit large attacking power to the counter material. Therefore, optimization of the adding amount is necessary.

What is claimed is:

1. A copper-based sintering sliding material wherein finely grinded nonmetallic particles comprising one or more kind(s) selected from oxides, carbides, nitrides and carbonitrides are dispersed in an amount ranging from 0.2% by volume, inclusive, to 4% by volume, exclusive.

2. The copper-based sintering sliding material according to claim 1, wherein said nonmetallic particles are oxide-based heat shock resistant ceramics comprising one or two or more selected from SiO₂ and/or Si, Al, Li, Ti, Mg, and Zr.

3. The copper-based sintering sliding material according to claim 1, wherein said nonmetallic particles are one or more kind(s) selected from carbides, nitrides and carbonitrides of W, Ti, Mo or V, and/or cermet particles obtained by sintering the same with Co and/or Ni.

4. The copper-based sintering sliding material according to claim 1, wherein said nonmetallic particles are adjusted to particles having an average particle diameter of less than or equal to 70 μm and/or fibrous forms.

5. The copper-based sintering sliding material according to claim 1, wherein metal and/or alloy particles comprising Mo, W, Cr, Co, Fe, and Fe—C are dispersed in an amount of 0.5 to 5.0% by weight.

6. The copper-based sintering sliding material according to claim 1, wherein less than or equal to 1% by weight of MnS and/or less than or equal to 1% by weight of graphite are/is contained.

7. The copper-based sintering sliding material according to claim 6, wherein said MnS and/or graphite has an average particle diameter in the range of 20 to 200 μm, inclusive.

8. The copper-based sintering sliding material according to claim 1, wherein at least Sn is contained in an amount of 1 to 16% by weight, and Pb is contained in an amount of 0 to 25% by weight.

9. The copper-based sintering sliding material according to claim 8, wherein one or more alloy element(s) selected from Zn, Mn, Be, Mg, Ag and Bi, and/or a solid lubricant such as MoS₂, CaF₂ and WS₂ are/is further contained.

10. The copper-based sintering sliding material according to claim 1, wherein 12 to 16% by weight of Sn is added and a Cu—Sn compound phase is dispersedly precipitated in a structure of the sintering sliding material.

11. The copper-based sintering sliding material according to claim 10, wherein an alloy element of one or more kind(s) selected from Zn, Mn, Be, Mg, Ag and Bi and/or a solid lubricant such as MoS₂, CaF₂ and WS₂ are/is further contained.

12. A copper-based sintering sliding material, wherein one or more intermetallic compound(s) comprising two or more selected from Ni, Si, Ti, Co, Fe, Al, V and P is/are dispersed, and the adding amount thereof is in the range of 0.5 to 10% by weight in terms of a total adding amount of two or more selected from Ni, Si, Ti, Co, Fe, Al, V and P.

13. The copper-based sintering sliding material according to claim 12, wherein nonmetallic particles comprising one or more kind(s) selected from oxides, carbides, nitrides and carbonitrides are contained in an amount ranging from 0.1% by volume, inclusive, to 4% by volume, exclusive.

14. The copper-based sintering sliding material according to claim 12, wherein metal and/or alloy particles comprising Mo, W, Cr, Co, Fe, and Fe—C are dispersed in an amount of 0.5 to 5.0% by weight.

15. The copper-based sintering sliding material according to claim 12, wherein less than or equal to 1% by weight of MnS and/or less than or equal to 1% by weight of graphite are/is contained.

16. The copper-based sintering sliding material according to claim 15, wherein said MnS and/or graphite has an average particle diameter in the range of 20 to 200 μm, inclusive.

17. The copper-based sintering sliding material according to claim 12, wherein at least Sn is contained in an amount of 1 to 16% by weight, and Pb is contained in an amount of 0 to 25% by weight.

18. The copper-based sintering sliding material according to claim 17, wherein one or more alloy element(s) selected from Zn, Mn, Be, Mg, Ag and Bi, and/or a solid lubricant such as MoS₂, CaF₂ and WS₂ are/is further contained.

19. The copper-based sintering sliding material according to claim 12, wherein 12 to 16% by weight of Sn is added and a Cu—Sn compound phase is dispersedly precipitated in a structure of the sintering sliding material.

20. The copper-based sintering sliding material according to claim 19, wherein an alloy element of one or more kind(s) selected from Zn, Mn, Be, Mg, Ag and Bi and/or a solid lubricant such as MoS₂, CaF₂ and WS₂ are/is further contained.

21. A copper-based sintering sliding material, wherein one or more intermetallic compound(s) comprising two or more selected from Cu, Sn, Ca, Mn, Cr, Mo, W, Sb and Te is/are dispersed, and the adding amount thereof is in the range of 0.1 to 10% by volume in terms of intermetallic compound.

22. The copper-based sintering sliding material according to claim 21, wherein nonmetallic particles comprising one or more kind(s) selected from oxides, carbides, nitrides and carbonitrides are contained in an amount ranging from 0.1% by volume, inclusive, to 4% by volume, exclusive.

23. The copper-based sintering sliding material according to claim 21, wherein metal and/or alloy particles comprising Mo, W, Cr, Co, Fe, and Fe—C are dispersed in an amount of 0.5 to 5.0% by weight.

24. The copper-based sintering sliding material according to claim 21, wherein less than or equal to 1% by weight of MnS and/or less than or equal to 1% by weight of graphite are/is contained.

25. The copper-based sintering sliding material according to claim 24, wherein said MnS and/or graphite has an average particle diameter in the range of 20 to 200 μm, inclusive.

26. The copper-based sintering sliding material according to claim 21, wherein at least Sn is contained in an amount of 1 to 16% by weight, and Pb is contained in an amount of 0 to 25% by weight.

27. The copper-based sintering sliding material according to claim 26, wherein one or more alloy element(s) selected from Zn, Mn, Be, Mg, Ag and Bi, and/or a solid lubricant such as MoS₂, CaF₂ or WS₂ is further contained.

28. The copper-based sintering sliding material according to claim 21, wherein 12 to 16% by weight of Sn is added and a Cu—Sn compound phase is dispersedly precipitated in a structure of the sintering sliding material.

29. The copper-based sintering sliding material according to claim 28, wherein an alloy element of one or more kind(s) selected from Zn, Mn, Be, Mg, Ag and Bi and/or a solid lubricant such as MoS₂, CaF₂ and WS₂ are/is further contained.

30. A copper-based sintering sliding material, wherein one or more intermetallic compound(s) comprising two or more selected from Ni, Si, Ti, Co, Fe, Al, V and P is/are dispersed, and further one or more intermetallic compound(s) comprising two or more selected from Cu, Sn, Ca, Mn, Cr, Mo, W, Sb and Te is/are dispersed, and the adding amount thereof is in the range of 0.1 to 10% by volume in terms of intermetallic compound.

31. The copper-based sintering sliding material according to claim 30, wherein nonmetallic particles comprising one or more kind(s) selected from oxides, carbides, nitrides and carbonitrides are contained in an amount ranging from 0.1% by volume, inclusive, to 4% by volume, exclusive.

32. The copper-based sintering sliding material according to claim 30, wherein metal and/or alloy particles comprising Mo, W, Cr, Co, Fe, and Fe—C are dispersed in an amount of 0.5 to 5.0% by weight.

33. The copper-based sintering sliding material according to claim 30, wherein less than or equal to 1% by weight of MnS and/or less than or equal to 1% by weight of graphite are/is contained.

34. The copper-based sintering sliding material according to claim 33, wherein said MnS and/or graphite has an average particle diameter in the range of 20 to 200 μm, inclusive.

35. The copper-based sintering sliding material according to claim 30, wherein at least Sn is contained in an amount of 1 to 16% by weight, and Pb is contained in an amount of 0 to 25% by weight.

36. The copper-based sintering sliding material according to claim 35, wherein one or more alloy element(s) selected from Zn, Mn, Be, Mg, Ag and Bi, and/or a solid lubricant such as MoS₂, CaF₂ or WS₂ is further contained.

37. The copper-based sintering sliding material according to claim 30, wherein 12 to 16% by weight of Sn is added and a Cu—Sn compound phase is dispersedly precipitated in a structure of the sintering sliding material.

38. The copper-based sintering sliding material according to claim 37, wherein an alloy element of one or more kind(s) selected from Zn, Mn, Be, Mg, Ag and Bi and/or a solid lubricant such as MoS₂, CaF₂ or WS₂ is further contained.

39. A multi-layered sintered sliding member formed by sinter-bonding the copper-based sintering sliding material according to any one of claims 1 to 38 to an iron-based material.

40. The multi-layered sintered sliding member according to claim 39 formed by sinter-bonding a press molded body of a sintering sliding material containing Sn and/or Pb to an iron-based material, wherein as components of a sintered body sinter-bonded with said iron-based material, one or more element(s) selected from Cr, Si, Al, P and Ti is/are contained in an amount of 0.1 to 2% by weight, the element(s) being superior in affinity to iron to copper and stabilizing the α phase rather than γ phase of iron.

41. The multi-layered sintered sliding member according to claim 39, wherein in spreading mixed powder having a composition of the sintering sliding material containing Sn and/or Pb on a steel plate, in performing a primary sinter-bonding at a temperature of more than or equal to 810° C., mechanically densifying the spread sintered layer, and performing a secondary sinter-bonding for use, one or more kind(s) selected from Si, Al, Ti and Cr that allow the sintered layer to expand and/or nonmetallic particles that prevent the sintered layer from contracting is/are contained so that the mixed powder layer spread at the time of primary sintering will not peel off the steel plate due to contraction during sintering.

42. The multi-layered sintered sliding member according to claim 41, wherein the sintered layer at the time of said primary sintering is allowed to expand by using Cu—Sn-based alloy powder containing Sn of Cu30% by weight Sn or more and/or Sn raw powder as an adding method of Sn.
